(19) United States
(12) Patent Application Publication
(10) Pub. No.: US 2014/0244457 A1
(43) Pub. Date: Aug. 28, 2014

(54) SYSTEMS AND METHODS FOR GENERATING OUTPUTS IN RESPONSE TO EXAMINATION OF RECORDS

(71) Applicants: Bryan R. Howell, Greensboro, NC (US); Jason A. Moore, Greensboro, NC (US); R. Alan Neely, Greensboro, NC (US); Jim L. Buttonow, Greensboro, NC (US)

(72) Inventors: Bryan R. Howell, Greensboro, NC (US); Jason A. Moore, Greensboro, NC (US); R. Alan Neely, Greensboro, NC (US); Jim L. Buttonow, Greensboro, NC (US)

(21) Appl. No.: 14/113,154

(22) PCT Filed: Feb. 24, 2011
(86) PCT No.: PCT/US11/26002

§ 371 Date: May 15, 2014

Related U.S. Application Data
(60) Provisional application No. 61/307,921, filed on Feb. 25, 2010.
(60) Provisional application No. 61/364,239, filed on Jul. 14, 2010.

(51) Int. Cl. G06Q 40/00

(52) U.S. Cl. CPC G06Q 40/10
USPC 705/31

(57) ABSTRACT

Systems and methods for generating an electronic output in response to an examination of a customer's records are shown and described. In one embodiment, a system includes a tax analysis system (TAS) server including a retriever code segment (RCS), a transformer code segment, an analysis engine code segment (AECS), and an output code segment. In another embodiment, a method includes extracting customer tax records; transforming the extracted tax records to create a transformed tax record (TTRec); and analyzing TTRec using an analysis engine code segment (AECS). This method may also include generating an output based on AECS analysis.

### RELATED APPLICATIONS

This application claims priority to PCT/US2011/26002, filed Feb. 24, 2011; U.S. Patent Application No. 61/307,921, filed 25 Feb. 2010; and U.S. Patent Application No. 61/364,239, filed 14 Jul. 2010.

### FIELD OF TECHNOLOGY

The current disclosure relates to systems and methods for generating electronic outputs in response to examination of records, for example, a tax return.

### BACKGROUND

Tax returns are reports filed with a federal, state, or local tax collection agency containing information used to calculate taxes due, e.g., income tax. Tax collection agencies (or tax agencies) may vary somewhat by nationality, state, municipality, etc. The Internal Revenue Service (IRS) is an example of a federal tax collection agency in the United States of America. The North Carolina Department of Revenue is an example of a state tax collection agency in the state of North Carolina.

After being filed, tax returns may be examined (or audited) by the tax agency for correctness. Agencies may examine returns at random or based on some predetermined criteria, e.g., based on an earned income tax credit (EITC), etc. Examinations will also typically involve some response or interaction with the taxing agency.

Applicants have developed, inter alia, systems and methods for response or interaction with a taxing agency during the examination of a tax return. The disclosure also includes systems and methods to improve response or interaction with a taxing agency regarding other tax records.

In addition, the current disclosure provides systems and methods to improve response or interaction with other agencies, e.g., at least one agency within at least one of the Department of Agriculture, the Department of Commerce, the Department of Defense, the Department of Education, the Department of Energy, the Department of Health and Human Services, the Department of Homeland Security, the Department of Housing and Urban Development, the Department of the Interior, the Department of Justice, the Department of Labor, the Department of State, the Department of Transportation, the Department of the Treasury, the Department of Veterans Affairs, independent agencies, state and local counterparts to any of the above, etc.

### SUMMARY

The current disclosure includes systems and methods for generating an output in response to an examination of a customer's tax return. In many examples, the output will be an electronic output, with the electronic output being part of a larger examination solution implemented by the system and/or method. In operation, the inventions can be used to efficiently and accurately resolve the examination of a tax return.

In one example, the disclosure includes a tax analysis system (TAS) for generating at least one output in response to a tax return examination. In another example, a system includes a TAS server including a retriever code segment (RCS), a transformer code segment, an analysis engine code segment (AECS), and an output code segment.

In another example, the disclosure is directed to a method of analyzing transformed tax records and generating an electronic output based on the analysis. In another example, a method includes extracting customer tax records; electronically transforming the extracted tax records using a record transforming code segment (RecTCS) to create a transformed tax record (TTRec) for the customer; analyzing TTRec using an analysis engine code segment (AECS) contained on the TAS server; and generating an electronic output based on AECS analysis.

In another example, a method includes extracting customer tax records; sending the extracted customer tax records to the TAS server; storing the tax records in a customer database; analyzing the tax records; and generating an output based on analysis. In some examples, any number of these steps may be performed manually.

The disclosure is also directed to computer readable media, for example, a disk containing at least one of RecTCS and AECS.

The inventions contained herein can also be used to efficiently and accurately resolve issues regarding other tax records in an agency, e.g., any discrepancy between a customer and an agency related to the accuracy of tax records.

The inventions contained herein can also be used to efficiently and accurately resolve record keeping issues with other agencies, e.g. agencies within any of the Departments listed above.

The above summary was intended to summarize certain embodiments of the disclosure. Systems and methods will be set forth in more detail, along with examples demonstrating efficacy, in the figures and detailed description below. It will be apparent, however, that the detailed description is not intended to limit the present invention.

### BRIEF DESCRIPTION OF THE FIGURES

FIG. 1 represents a conceptual diagram of a tax analysis system (TAS) as described herein.

FIG. 2 is a flowchart illustrating a method for generating a solution, including at least one electronic output, in response to an examination of a customer's tax return.

FIG. 3 illustrates an environment in which a TAS system may operate.

FIG. 4 illustrates hardware components which may be found in one example of a customer computer.

FIG. 5 illustrates hardware components which may be found in one example of a retriever computer.

FIG. 6 illustrates a schematic diagram of exemplary system and environmental architecture.

FIG. 7 illustrates the structure and interaction of components in one embodiment of a TAS.

FIG. 8 illustrates operations performed by a new account codes segment NAGS.

FIG. 9 illustrates operations performed by a retriever code segment (RCS).

FIG. 10 illustrates exemplary steps in the process of electronically retrieving customer tax records.

FIG. 11 illustrates operations performed by a transformer code segment.

FIG. 12 illustrates operations performed by analysis engine code segment (AECS) according to one embodiment.

FIG. 13 illustrates operations performed by analysis engine code segment (AECS) according to another embodiment.

FIG. 14 illustrates an example of other output operations performed by analysis engine code segment (AECS).

FIG. 15 illustrates an example of other operations performed by an AECS.

FIG. 16 illustrates process performed by one embodiment of interview generating rule code segment (IGRCS).

FIG. 17 illustrates operations performed by one embodiment of new account code segment (NACS).

FIG. 18 illustrates operations performed by another embodiment of new account code segment (NACS).

FIGS. 19 and 20 illustrate an example of a TAS system in use to implement solution outputs.

FIG. 21 illustrates exemplary stream line installment agreement (SLIA) operations.

FIG. 22 illustrates various operations which may be performed in one example of qualifying filing compliance.

FIG. 23 illustrates various operations which may be performed in one example of qualifying payment compliance.

FIG. 24 illustrates various operations which may be performed in one example of qualifying tax debt.

FIG. 25 illustrates various operations which may be performed in another example of qualifying tax debt.

FIG. 26 illustrates operations performed by one embodiment of a Fuzzy Meter.

FIG. 27 illustrates various operations that may be performed when calculating SLIA term according to one embodiment.

FIG. 28 illustrates various operations that may be performed when qualifying SLIA financial feasibility according to one embodiment.

FIG. 29 illustrates some outputs that may be provided when using a TAS process, an SLIA process, or some other process.

FIG. 29a illustrates one example of a system generating outputs including offers of financial services.

FIG. 30 illustrates various user feedback operations that may be used in a TAS system according to one embodiment.

FIG. 31 illustrates various coaching operations that may be used in a TAS system according to one embodiment.

FIG. 32 illustrates the structure and interaction of components in another embodiment of a TAS server.

FIG. 33 illustrates another embodiment of a TAS server.

FIG. 34 illustrates various RCS operations that may be used in a TAS system according to one embodiment.

FIG. 35 illustrates various ILL fuzzy meter operations that may be used in a TAS system according to one embodiment.

FIG. 36 illustrates operations performed by one embodiment of record transforming code segment (RecTCS).

FIG. 37 illustrates operations performed by one embodiment of rule transforming code segment (RuTCS).

FIG. 38 illustrates operations performed by one embodiment of examination transforming code segment (ExTCS).

FIG. 39 illustrates operations performed by one embodiment of current situation code segment (CSTCS).

FIG. 40 illustrates operations performed by one embodiment of reference transformer code segment (RefTCS).

FIG. 41 illustrates operations performed by one embodiment of report generating code segment.

FIG. 42 illustrates operations performed by another embodiment of report generating code segment.

FIG. 43 illustrates one embodiment of a web portal or interface for secure sign up,

FIG. 44 illustrates an overview of one embodiment of a TAS in operation.

FIGS. 45a, 45b, 45c, and 45d provide another example of a tax system, as described herein, in operation.

FIG. 45e illustrates exemplary solution paths categorized based on debt, specifics to a particular business, liability, and examination specifics.

FIG. 46 represents a conceptual diagram of an analysis system (AS).

### DETAILED DESCRIPTION OF EXEMPLARY EMBODIMENTS

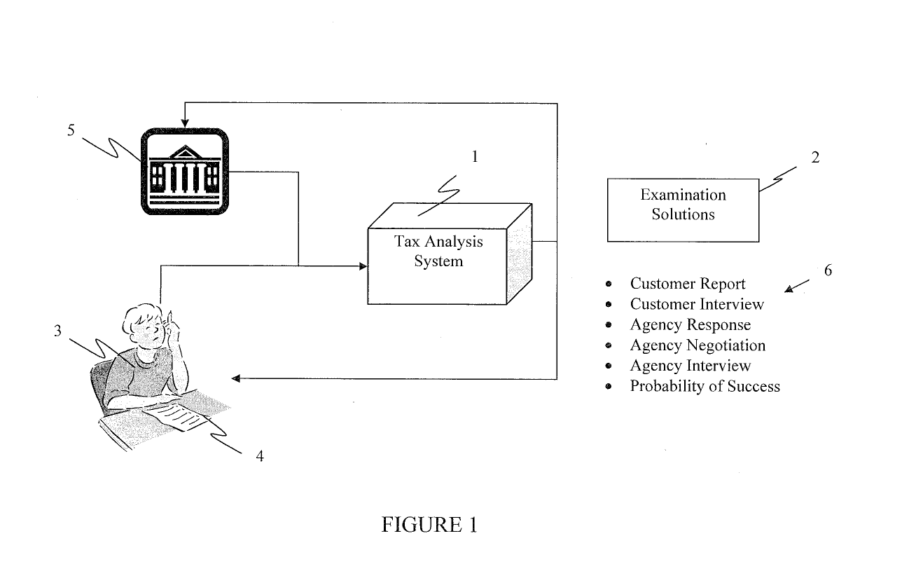

FIG. 1 represents a conceptual diagram of a tax analysis system (TAS) as described herein. TAS 1 performs operations to deliver examination solutions 2 (also referred to herein as “solutions”), to a customer 3 trying to respond to a tax return examination 4 received from a tax agency 5, e.g. the IRS or a state tax agency. Exemplary solutions 2 include: 30-60 day full repayments; stream lined installment agreements (SLIAs); paydowns with SLIA; installment agreements based on ability to pay; conditional installment agreements; lifestyle installment agreements; currently not collectible (CNC) responses; lien options; partial pay installment agreements (PPIA); offers in compliance (OIC); interim agreements, etc. Solutions 2 may be comprised of various electronic outputs 6, produced at various times throughout the solution implementation for achieving the solution. Exemplary outputs include electronic customer reports, electronic customer interviews, electronic agency responses, electronic agency negotiation coaching, electronic agency interviews, electronic probabilities of success, general coaching, etc. It should be noted that in some embodiments, outputs may additionally or alternatively include paper outputs. It should also be noted that the current disclosure is directed to, inter alia, web-based and/or network systems. Further, TAS systems are not limited to providing outputs in response to examination of returns. Systems and methods of the disclosure can also be used to provide outputs in response to issues regarding any tax records in an agency, e.g., any discrepancy between a customer and an agency related to tax records.

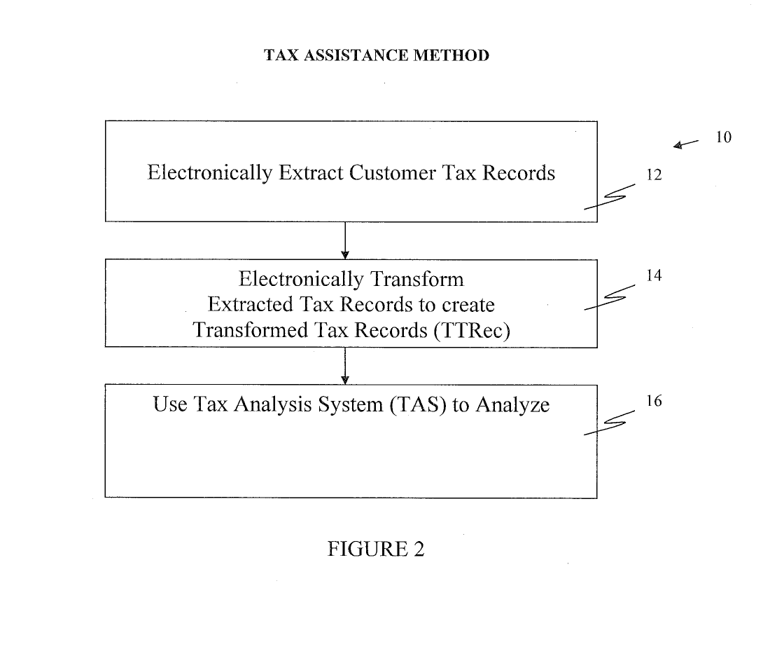

FIG. 2 is a flowchart illustrating a method 10 for generating a solution, including at least one electronic output, in response to an examination of a customer's tax return according to one embodiment of the disclosure. In operation 12, customer tax records are extracted, for example, from customer records or from a tax agency database. In operation 14, extracted tax records are transformed to create transformed tax records (TTRec). In operation 16, the TTRec are analyzed. The result of the analysis includes at least one electronic output as part of an examination solution. Steps 12, 14, and 16 are performed by a TAS, for example by various code segments of a TAS located on a server or other computer.

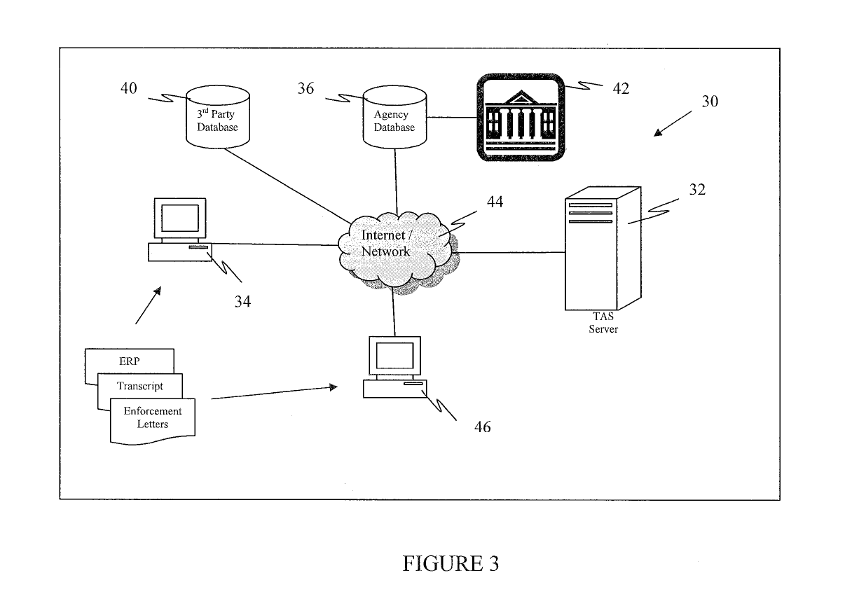

FIG. 3 illustrates an environment 30 in which a TAS system located, at least in part, on TAS sever 32 may operate. In environment 30, TAS server 32 is in communication with customer computer 34. TAS server 32 may also be in communication with a 3^{rd} party database, e.g., agency database 36 or another third party database 40. Agency databases are considered to be those databases in communication with tax agency 42, e.g., the IRS, and containing tax-related records. Communication may be achieved via the Internet or other network 44. In many embodiments, communication with agency database 36 is achievable via an agency interview, e.g., via a telephonic interview for example. TAS server 32 may also be in communication with a retriever computer 46. Retriever computer 46 may be used by a retriever employed by the TAS service provider, e.g., one who facilitates the retrieval of information discussed herein or additional information. Exemplary components in the environment will also be explained in more detail below.

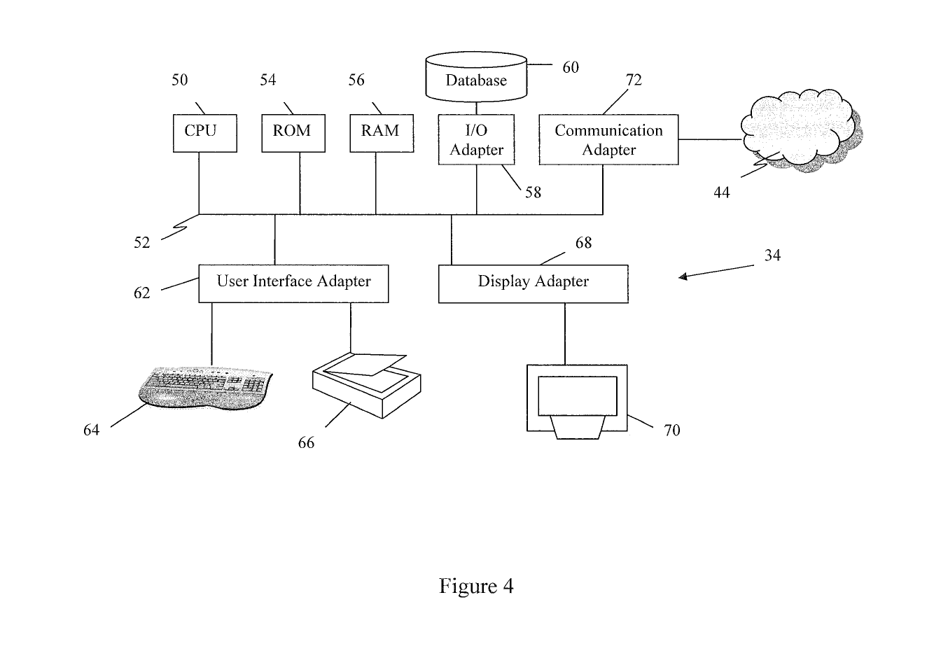

FIG. 4, for example, illustrates hardware components which may be found in one example of a customer computer in communication with Internet/network 44. Computer 34 has central processing unit 50, and a variety of other components connected by bus 52. For example, computers may include read only memory (ROM) 54, random access memory (RAM) 56, an input output adapter 58 for connecting devices e.g. database 60, to the bus, a user interface adapter 62 for connecting to a keyboard 64, scanner 66, mouse, etc. (not shown), a display adapter 68 for connecting a monitor 70 to the bus, and a communications adapter 72 for connecting to Internet/network 44. In other embodiments, customer computers may have different configurations or may include different components. A tax professional's computer may also be considered a customer computer as used herein. In many applications, for example, tax professionals may be using the disclosed systems and/or methods to achieve any of the variety of benefits disclosed herein on behalf of their customers.

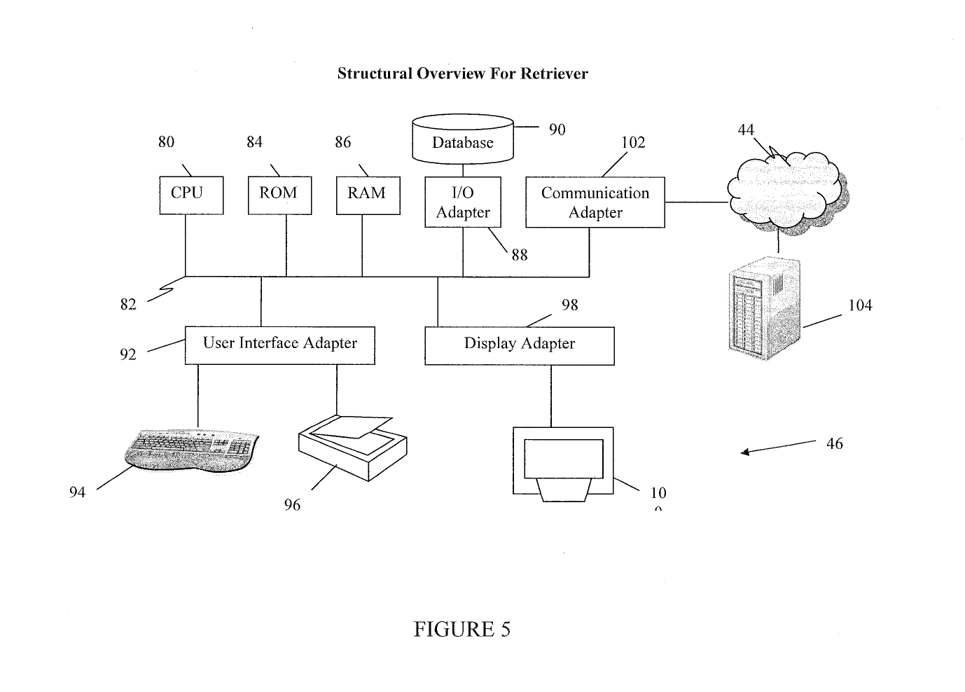

FIG. 5 illustrates hardware components, which may be found in one example of a retriever computer 46 in communication with Internet/network 44 Computer 46 has central processing unit 80, and a variety of other components connected by bus 82. For example, computers may include read only memory (ROM) 84, random access memory (RAM) 86, an input output adapter 88 for connecting devices e.g. database 90, to the bus, a user interface adapter 92 for connecting to a keyboard 94, scanner 96, mouse, etc. (not shown), a display adapter 98 for connecting a monitor 100 to the bus, and a communications adapter 102 for connecting to Internet/network 44. In this depiction, retriever computer is shown as connected to TAS server 104 through network 44. In other embodiments, retriever computers may have different configurations or may include different components.

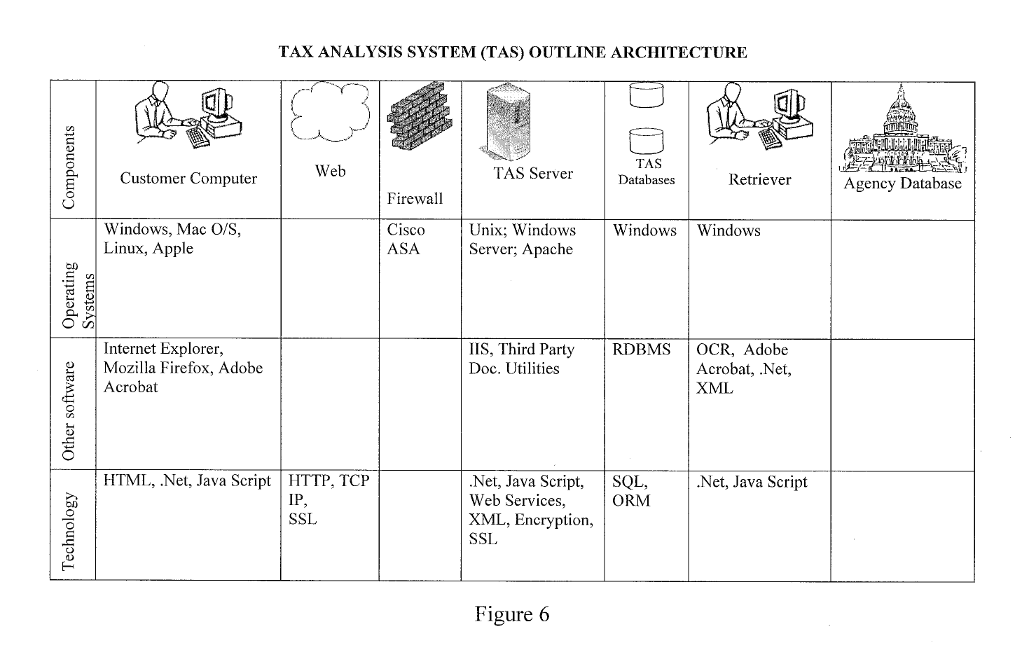

FIG. 6 illustrates a schematic diagram of exemplary system and environmental architecture. These features are provided by way of illustration only, and may vary from embodiment to embodiment.

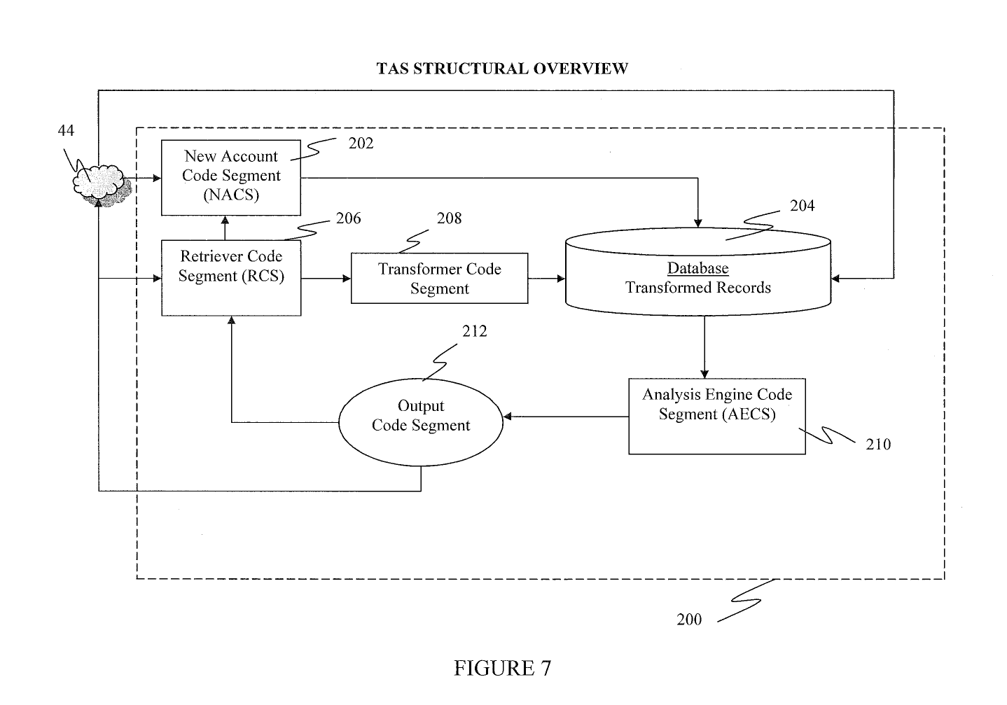

FIG. 7 illustrates the structure and interaction of components in one embodiment of a TAS 200, which may be located, at least in part, on a TAS server, which may be inclusive of a plurality of TAS servers. TAS 200 includes a new account codes segment (NAGS) 202 in communication with database 204. NACS operates to, inter alia, create a customer account in database 204. Retriever code segment (RCS) 206 is in communication with NAGS 202 and transformer code segment 208. RCS 206 may perform a variety of functions, including for example at least one of retrieving information from a customer computer, retrieving information from a 3^{rd} party database, and sending information requests to a customer computer. Transformer code segment 208 operates to transform information that has been retrieved into a storage and access schema for database 204. Database 204, thus contains transformed records generated by code segment 208. Database 204 may also contain transformed laws, rules, procedures, etc. from a tax agency. Database 204 is also in communication with analysis engine code segment (AECS) 210. AECS 210 generates an output based on transformed records and rules, e.g., those contained within database 204. Outputs may be particular to an overall solution strategy. AECS 210 output is received by output code segment 212. Output code segment may generate a variety of web-based or tangible outputs deliverable to Internet/network 44 or RCS 206, e.g. reports, interviews, requests for additional information, graphical representations, etc. Outputs generated by AECS 210 may also be convertible to paper copies for delivery.

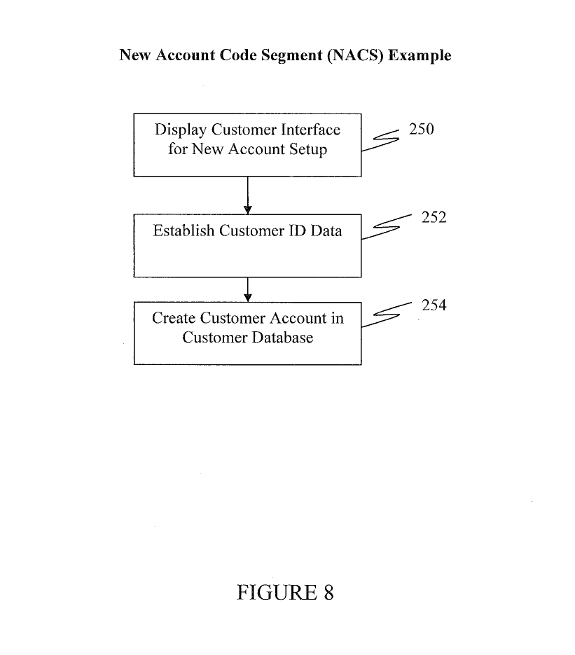

FIG. 8 illustrates operations performed by a new account codes segment NAGS according to one embodiment. In operation 250, the NACS codes to display a customer interface for new account setup. The customer interface will typically be a web page (not shown in this figure) displayed on the customer computer. In operation 252, the NAGS codes to establish customer ID data. In this embodiment, customer ID data may include at least one of a customer's name, a social security number, or an assigned ID number. In other embodiments, customer ID data may be or include other things. In operation 254, the NAGS creates an account in the customer database. The result includes at least one of a secure portal and the creation of login access.

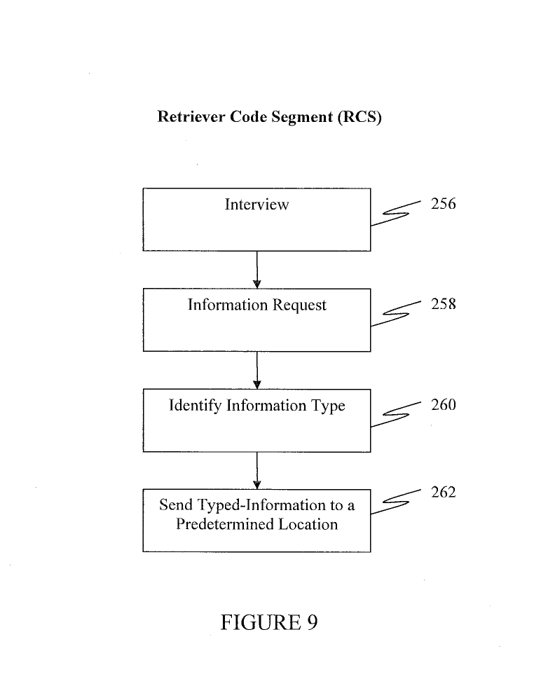

FIG. 9 illustrates operations performed by a retriever code segment (RCS) according to one embodiment. In operation 256, the RCS codes to interview, e.g., the customer. In this embodiment, interviewing includes sending a webpage to the customer computer including prompts for various pieces of information. For example, an interview may prompt for preliminary information, e.g., types of services desired, circumstantial summaries, financial summaries, permission to access a tax agency database or other financial service records on a customer's behalf, etc. In operation 258, the RCS codes to request information. The requested information could be, for example, a customer request to scan or fax a tax return or other financial information. The requested information could also be a tax agency request to scan or fax a tax return or other financial information. Financial information may include a variety of things, e.g., bank account information, real estate holdings, 401(k), annuity, stock holdings, insurance, credit card debt, etc. As such, RCS may have to request information from a variety of financial organizations or websites. In addition to performing such requests and aggregation itself, systems or RCSs may communication with account aggregation software or services of others, e.g., Yodlee, Inc. Further, the requested information could also be at least one of the inquiries of Table 1, or may be based on the types of services desired.

In operation 260, the RCS codes to indentify information type being retrieved. Identification may be achieved in a variety of ways, for example, a database containing identifying parameters may be consulted, tax agency trans codes may be identified, customer identify information may be recognized, etc. Table 1 also lists exemplary identified information type, e.g. status, compliance, history, profile, liquidity, financials, etc. In operation 262, the RCS sends typed-information to a predetermined location, e.g., the appropriate data base or portion of a database. In other examples, RCS may perform any of the operations above in isolation or in other combinations.

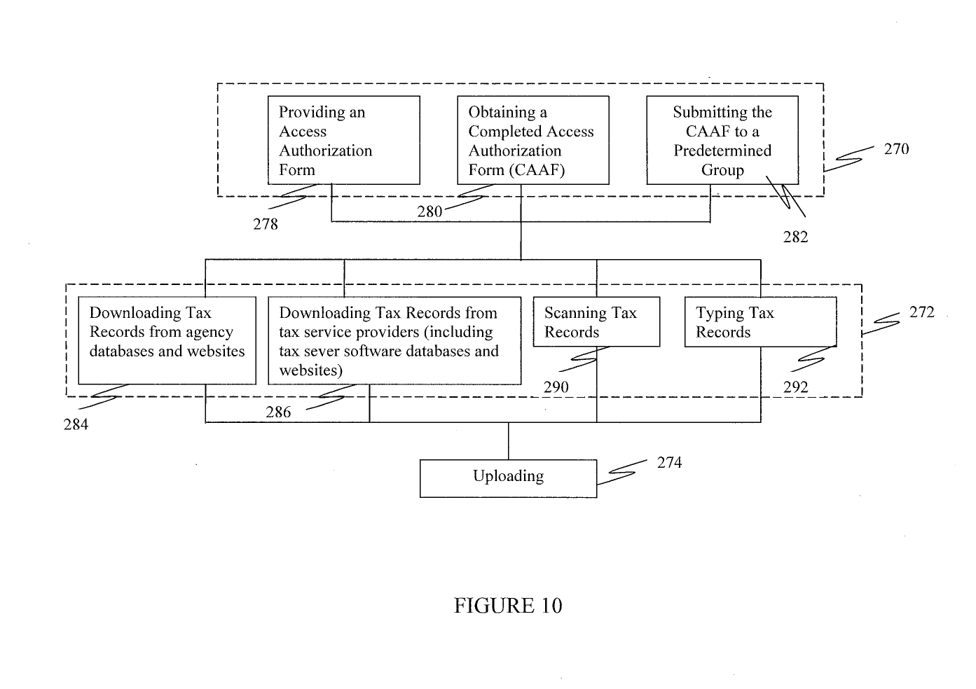

FIG. 10 illustrates various steps, at least one of which might be performed in the process of electronically retrieving customer tax records. The steps are generally broken down into permission operations 270, access operations 272, and uploading operations 274. Permission operations 270 may include at least one of providing an access authorization form in operation 278 (e.g. IRS Form 8821), obtaining a completed access authorization form (CAAF) in operation 280, and submitting a CAAF in operation 282. CAAFs allow service providers to represent a customer before a taxing agency. CAAFs may also be used to allow systems to access agency or financial institution records. Permission operations may be performed electronically, e.g. operation 278 may be performed by sending a webpage or attached document from a TAS server to a customer computer, or a TAS server may generate a form that is then physically sent to a customer. Operation 280 may be performed by retrieving a CAAF from a customer computer to a TAS server or by scanning a CAAF sent to the service provider. Operation 282 may be performed by sending a CAAF from a TAS server to a predetermined group. Groups may vary, but exemplary embodiments will include at least one of a federal tax agency, a state tax agency, or another group having pertinent customer tax records or financial information.

Access operations 272 may include at least one of downloading tax records from agency databases and websites in operation 284, downloading tax records from tax service providers in operation 286, scanning tax records in operation 290, and typing tax records in operation 292. Access operations may be performed at a customer computer or may be performed at a retriever computer. Uploading operation 274 refers to uploading the information or document, for example, retrieving from a customer or retriever computer, to the retriever code segment of a TAS server.

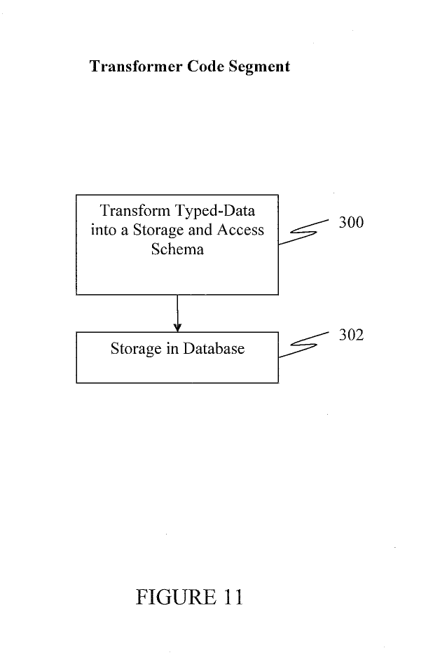

FIG. 11 illustrates operations performed by a transformer code segment according to one embodiment, for example, after information has been uploaded to a TAS server and typed by RCS. In operation 300, the transformer code segment codes to transform typed-data into a storage and access schema. In operation 302, code segment may also store transformed data in a database.

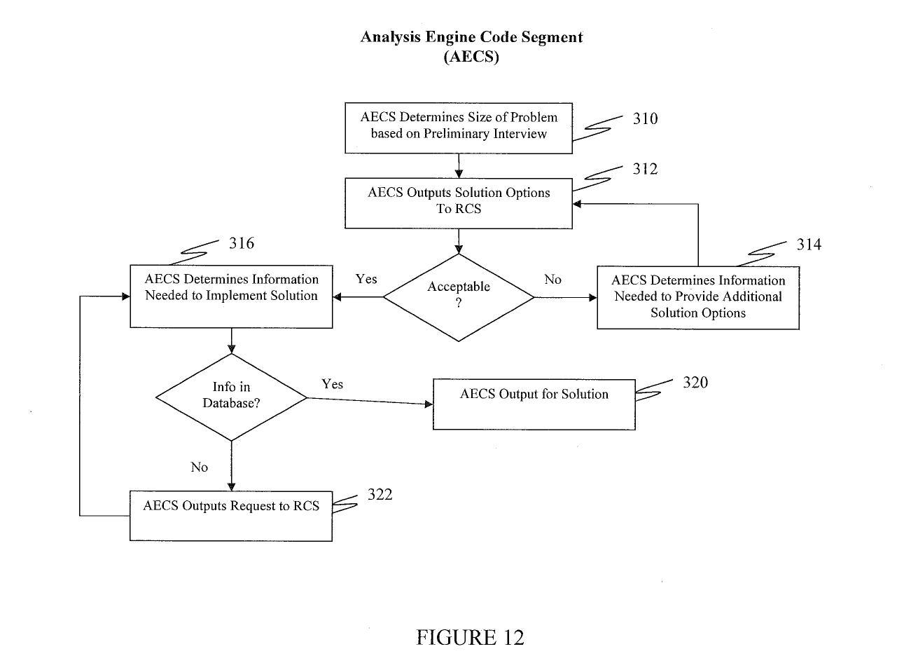

FIG. 12 illustrates operations performed by analysis engine code segment (AECS) according to one embodiment. In operation 310, AECS determines at least some of the specifics concerning a customer's tax problem based on, for example, a preliminary interview. The preliminary interview includes a web-based interface at the customer computer. In operation 312, AECS outputs solution options to the RCS, where they are sent to a web-based customer interface to allow the customer to determine if the proposed solutions are acceptable. If the proposed solutions are not acceptable, in operation 314, the AECS determines information needed to provide additional solutions and returns to operation 312 or a similar operation. If the proposed solutions are acceptable, in operation 316, the AECS determines the information needed to implement the solution. For example, the AECS may search transformed information contained within a system database. If the requisite information is in the database, the AECS outputs the solution in operation 320. If the requisite information is not in the database, the AECS may output a request for additional information in operation 322. As illustrated, operation 322 outputs the request for additional information to the RCS, for example, to be sent to a customer or an agency. In other embodiments, additional information may be requested in other ways, e.g., interviews.

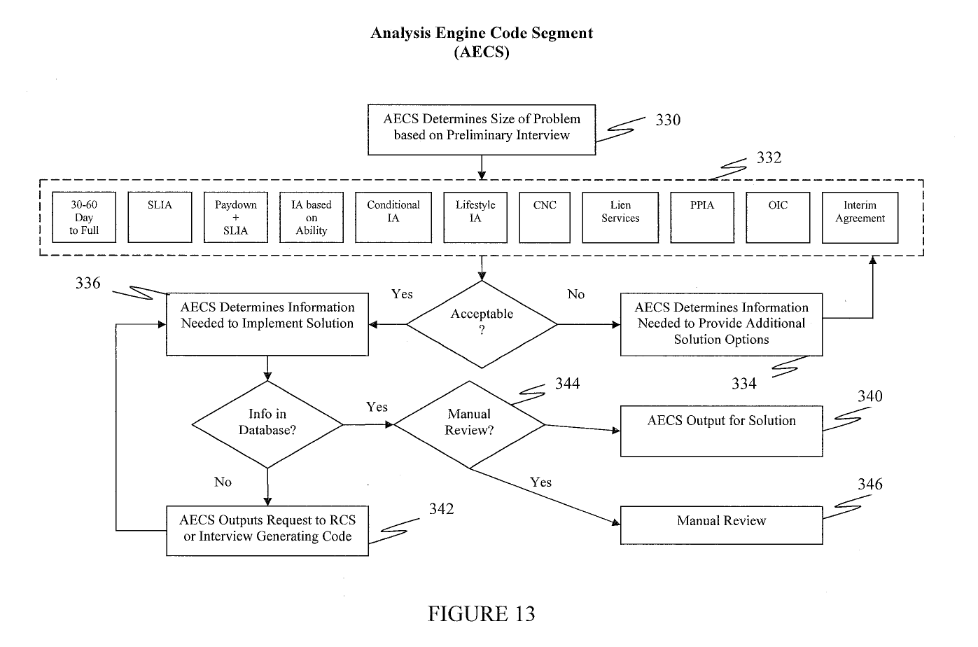

FIG. 13 illustrates operations performed by analysis engine code segment (AECS) according to another embodiment, somewhat similar to the embodiment above. In operation 330, AECS determines at least some of the specifics concerning a customer's tax problem based on a preliminary interview including, at least in part, a web-based interface at the customer computer. In operation 332, AECS outputs a solution option to the RCS based on operation 330. Solution options include at least one of: 30-60 day full repayments; stream lined installment agreements (SLIA); paydowns with SLIA; installment agreements based on ability to pay; conditional installment agreements; lifestyle installment agreements; currently not collectible (CNC) responses; lien options; partial pay installment agreements (PPIA); offers in compliance (OIC), and interim agreements. If the proposed solution is not acceptable, in operation 334, the AECS determines information needed to provide additional solutions and returns to operation 332 to propose an additional solution. If the proposed solution is acceptable, in operation 336, the AECS determines the information needed to implement the solution. If the requisite information is in a system database, the AECS outputs the solution in operation 340. If the requisite information is not in the database, the AECS may output a request for additional information in operation 322. As illustrated, operation 342 outputs the request for additional information to the RCS or to interview generating code.

In some examples, systems may also perform an operation to determine if manual review is desired, for example, as illustrated by operation 344. If it is determined that no manual review is needed, the system may proceed to operation 340 as discussed above. If it is determined that manual review is needed, the system may alert an operator to perform manual review in operation 346. Initiation of a manual review may include any of a variety of alerts, e.g. generating a prompt or email for a service provider employee to review. Any variety of pre-determined parameters may be used to initiate a manual review of a system-proposed solution. For example, any combination of the solutions in operation 332 may be predetermined to initiate a manual review, based on, for example, a particular user profile. Further, within each solution, there may be particular subsets that are predetermined to initiate a manual review, or particular combinations of subsets and user profiles.

In one example, operation 344 may be determined to initiate a manual review for a combination of a proposed OIC in combination with various user profiles. OICs may be a viable solution, for example, when reasonable collection potential is greater than the tax owed, which could be measured by comparing current assets to current monthly disposable income (e.g., income less expenses subject to IRS limitations). In such situations, any user profile that suggests a change in income may initiate manual review because the change could alter the viability of a proposed OIC solution. Exemplary user profiles include: an age that could be shortly qualifying for social security; an under-employed profile, e.g., where a person could soon be making more money but is temporarily unemployed, such as a doctor working as a lab technician until employment is available; etc. During the manual review operation, e.g., 346, the internal operator may contact the customer, or the system may contact the customer, to determine if the proposed solution is the most appropriate or if a revised solution may be needed.

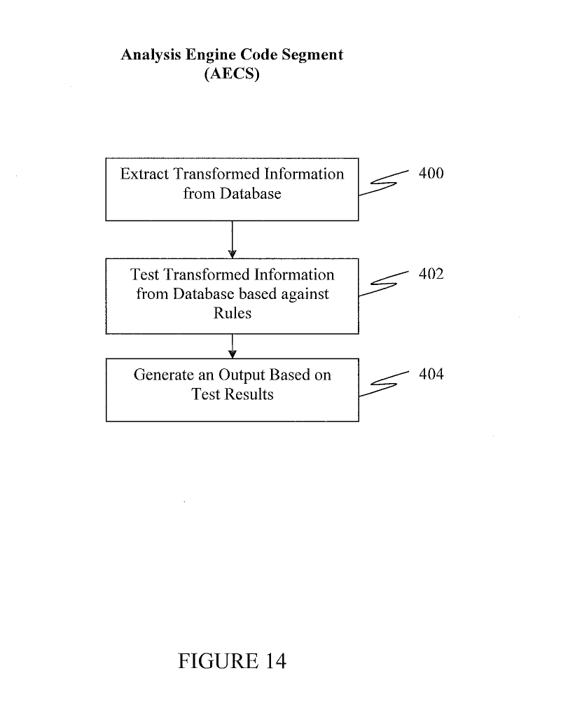

FIG. 14 illustrates other output operations performed by analysis engine code segment (AECS) according to any of the embodiments described above or an additional embodiment. In operation 400, the AECS codes to extract transformed information from the database. In operation 402, the AECS codes to test transformed information based on a rules set. Rules may vary from embodiment to embodiment, but will typically include rules transformed from at least one of tax codes, tax laws, and tax regulations, for example, United States tax law or a state's tax law. Co. In operation 404, the AECS codes to generate an output based on test results. Outputs may be sent to an output code segment to perform a variety of functions, e.g., generate electronic agency interviews, generate prompts for telephonic agency interviews, generate electronic customer interviews, generate electronic responses for customers to submit to an agency, generate electronic responses for customers to print and submit to an agency, request additional raw data, request additional information from previously requested raw data, etc.

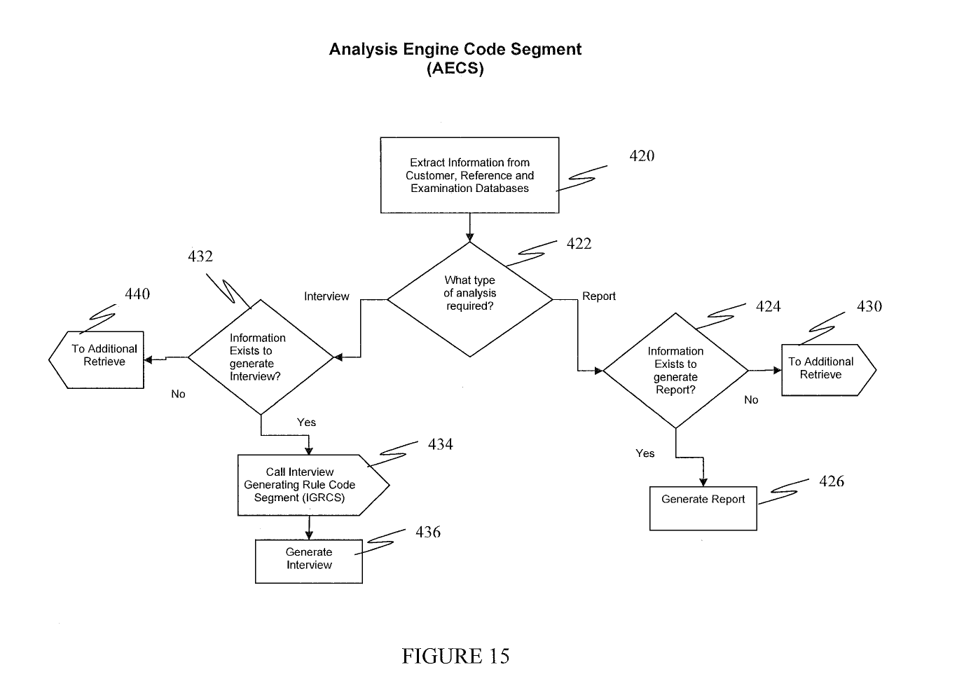

FIG. 15 illustrates other operations performed by an AECS according to any of the embodiments described above or an additional embodiment. In operation 420, the AECS codes to extract information from at least one of a customer database, a reference database, and an examination database. In operation 422, the AECS, the customer, or some combination, determines what type of analysis is required.

If it is determined that a report is required, in operation 430, the AECS determines if sufficient information exists in a database to generate the report. If sufficient information exists in the database, the AECS generates a report in operation 426. If sufficient information does not exist in the database, the AECS performs an additional retrieve in operation 430.

If it is determined that an interview is required, in operation 432, the AECS determines if information exists in a database to generate the interview. If sufficient information exists in the database, the AECS calls interview generating rule code segment (IGRCS) in operation 434. Using input from operation 434, an interview is generated in operation 436. If sufficient information does not exist in the database, the AECS performs an additional retrieve in operation 440.

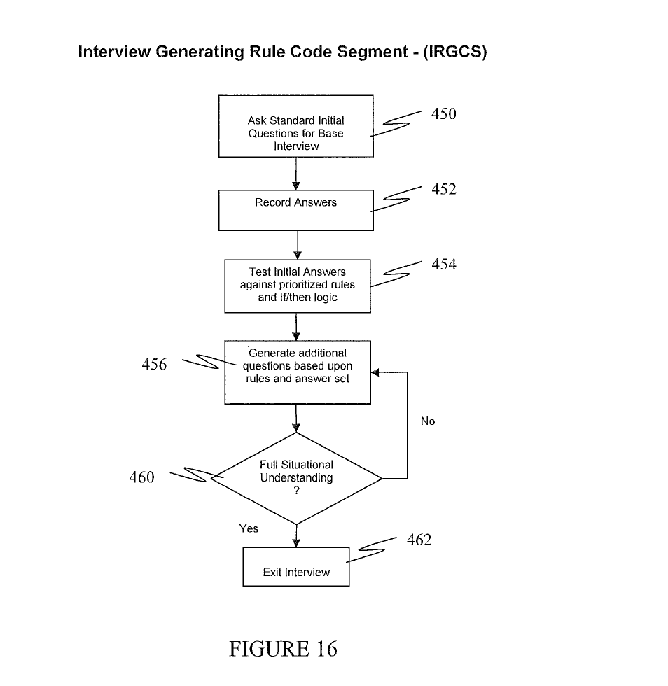

FIG. 16 illustrates process performed by one embodiment of interview generating rule code segment (IGRCS). In operation 450, the IRGCS codes to ask standard initial questions for a base interview. In operation 452, the IRGCS codes to record answers. In operation 454, the IRGCS tests initial answers against prioritized rules, e.g. in a rules database. In operation 456, the IRGCS may optionally generate additional questions based on rules and the answer set generated in operation 454. In operation 460, the IRGCS codes to determine if full situational understanding has been reached. If not, operation 456 is initiated. If so, an exit interview 462 is performed.

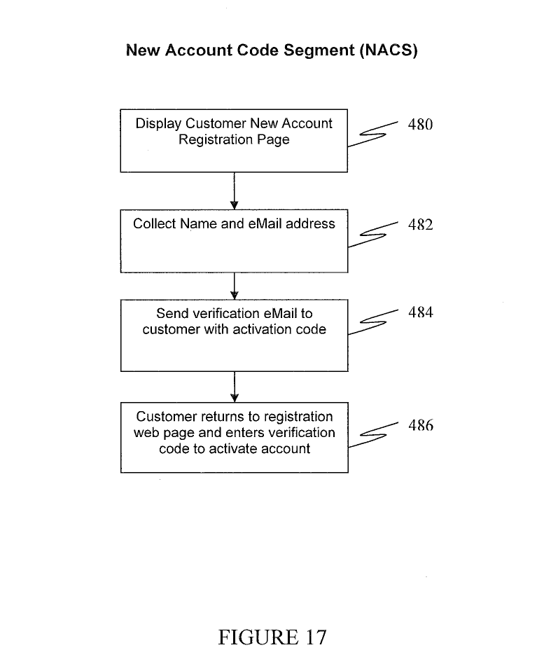

FIG. 17 illustrates operations performed by one embodiment of new account code segment (NACS). In operation 480, the NAGS codes to display a customer new account interface page. In operation 482, the NACS codes to collect at least one piece of indicia, such as a customer name or email address, etc. In operation 484, the NACS codes to send a verification email to the customer with an activation code. In operation 486, the NACS codes to activate a customer account once the customer returns to the registration and enters the verification code.

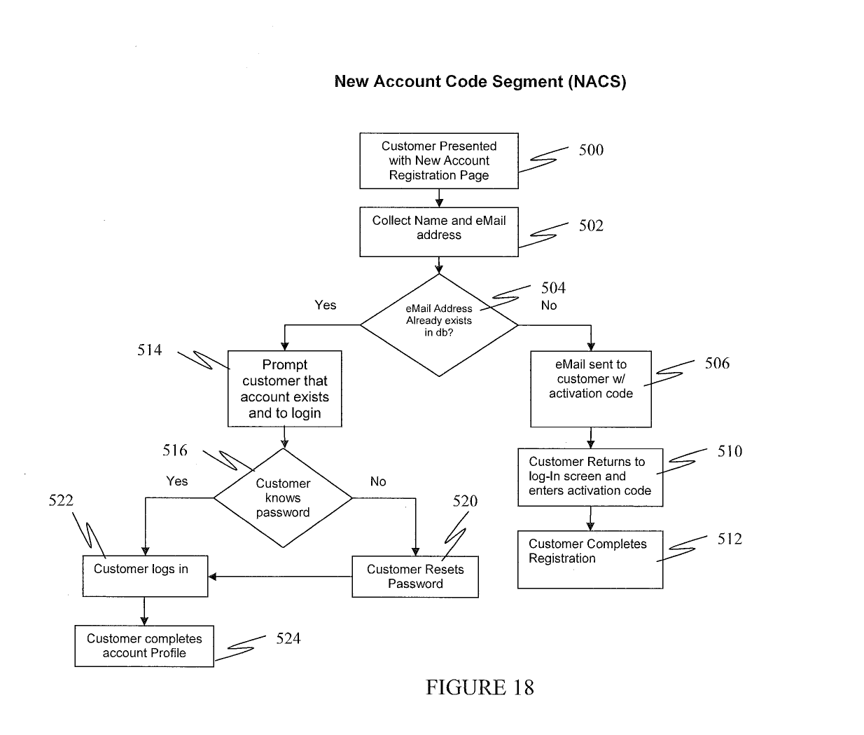

FIG. 18 illustrates operations performed by another embodiment of new account code segment (NACS). In operation 500, the NACS codes to display a customer new account interface page. In operation 502, the NACS codes to collect a customer name and email address. In operation 504, the NAGS codes to determine if the entered email address exists in the system database. If the customer email does not exist in the database, in operation 506, the NACS codes to send a verification email to the customer with an activation code. In operation 510, the NACS codes to activate a customer account once the customer returns to the registration and enters the verification code. In operation 512, the NACS codes to complete the customer registration process. If the customer email does exist in the database, in operation 514, the NACS codes to prompt the customer to login to the system. The NACS may optionally allow the customer to reset their password, as illustrated in operation 520 if the customer has forgotten their password. After login illustrated in operation 522, the NAGS prompts the customer to complete their account profile as illustrated in operation 524.

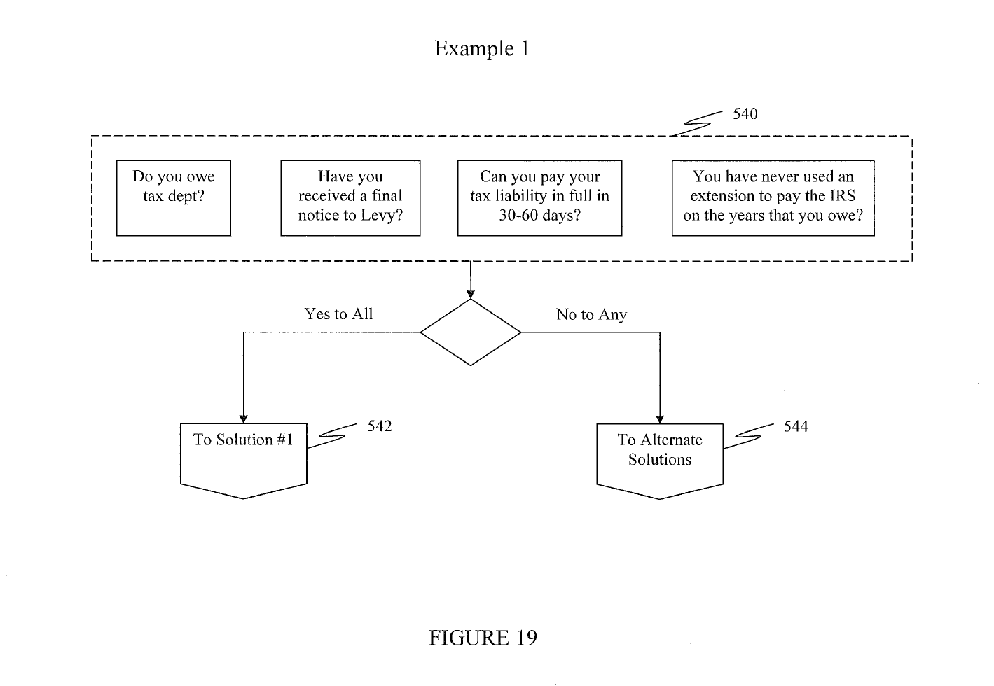

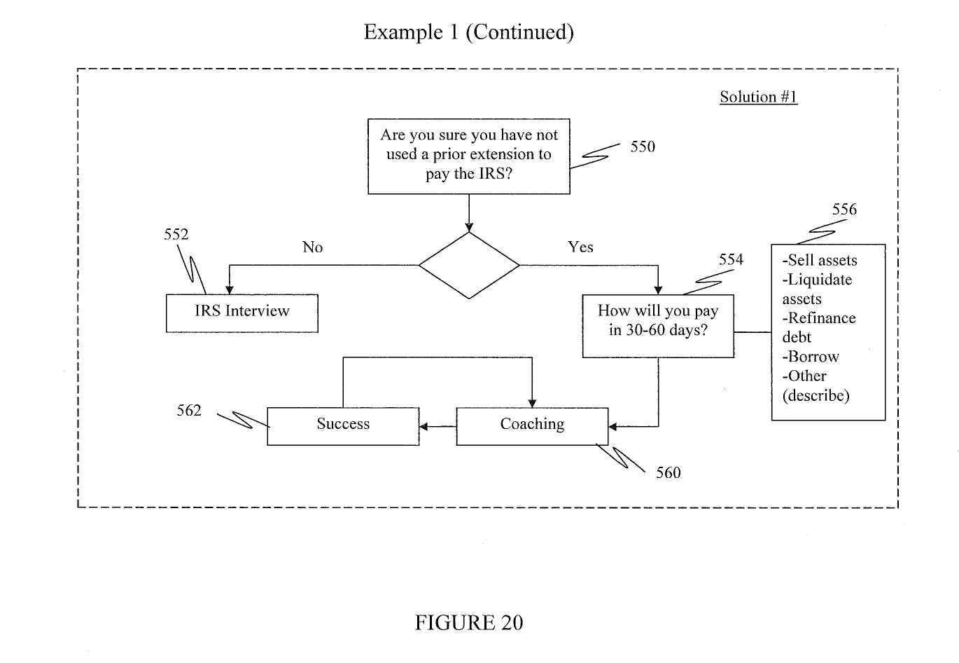

FIGS. 19 and 20 illustrate an example of a TAS system in use to implement solution outputs. As noted previously, the current disclosure is useful for implementing a variety of outputs, e.g., at least any of the electronic customer reports, electronic customer interviews, electronic agency responses, electronic agency negotiation coaching, electronic agency interviews, electronic probabilities of success, general coaching, etc. These outputs will typically be part of an overall system-determined solution. Exemplary factors for selecting solutions may be based on factors contained in Tables 2-12.

FIGS. 19 and 20 are illustrative of various outputs generated in a 30-60 day to full payment solution. In operation 540, preliminary questions are sent by the TAS server via webpage to a customer computer. Based on a customer's answers to predetermined questions presented, the system implements solution #1 operations, as illustrated in operation 542. For example, if the customer answers yes to the questions shown, solution #1 operations will be implemented. If the customer answers no to predetermined questions presented, the system implements alternative solutions, as illustrated in operation 544.

FIG. 20 illustrates solution #1 operations according to one embodiment. In operation 550, the system confirms that the customer has not used a prior extension to pay the IRS. If the customer is not sure about the status of prior extensions, the system implements an IRS interview in operation 552 to make the determination. If the customer is sure about extension status, the system determines how the customer will pay in operation 554. For example, in operation 556, the system may inquire about whether the customer will sell or liquidate assets, refinance debt, borrow money, or use some other means. In operation 560, the system produces coaching after a payment plan has been determined. In operation 562, the system determines whether the payment plan was successful. If the plan was not successful, the system may return to coaching the customer. The system may also determine the answer to at least one of the questions listed in Table 2.

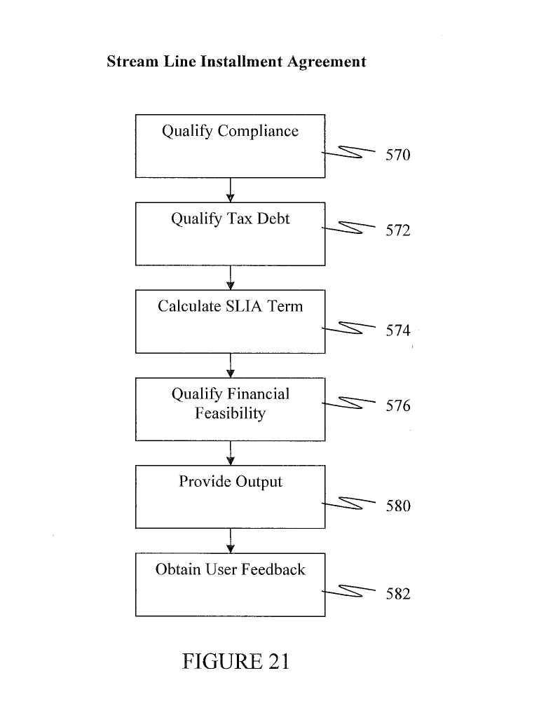

Returning back to FIG. 19, the system may also implement alternative solutions, e.g., a stream line installment agreement (SLIA). For example, FIG. 21 illustrates various stream line installment agreement (SLIA) operations. In operation 570, the system qualifies compliance, e.g., at least one of filing compliance or payment compliance. In operation 572, the system qualifies tax debt. In operation 574, the system calculates SLIA term. In operation 576, the system qualifies financial feasibility. In operation 580, the system provides output. In operation 582, the system obtains user feedback. In exemplary embodiments, SLIA operations will include at least one of these operations, more typically, at least operations 570, 572, and 574 are included. In some embodiments, all operations will be included.

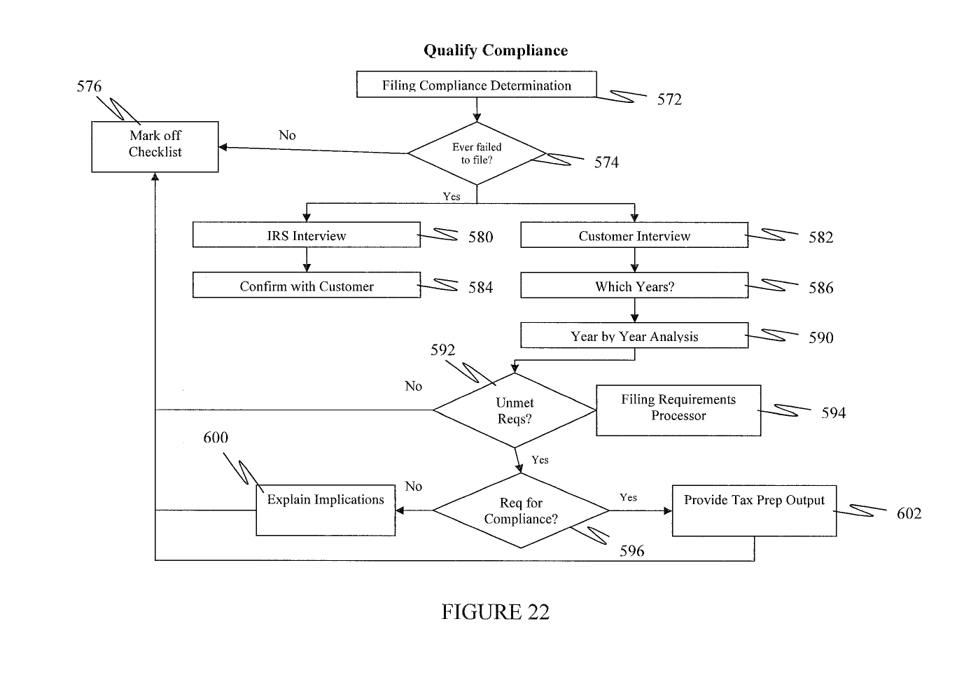

FIG. 22 illustrates various operations which may be performed in one example of qualifying filing compliance. In operation 572, the determination process is initiated. In operation 574, the system determines if the customer has ever failed to file a tax return. If the answer is no, the information is stored, for example, as indicated in operation 576. If the answer is yes, the system may implement either an IRS interview in operation 580, or a customer interview as in operation 582. If operation 580 is implemented, information obtained may be confirmed with the customer in operation 584. If operation 582 is implemented, in operation 586, the customer is prompted to enter in which years they failed to file a return. In operation 590, a year by year analysis may be performed by a portion of the AECS, e.g. a filing compliance wizard portion. In operation 592, the system determines if there are unmet filing requirements. This determination may be made, for example, using filing requirements processor 594. In operation 596, the system determines whether any unfiled returns are required for compliance. If there are unmet requirements, and those requirements are not required for compliance, the system explains the implications in operation 600. If the unmet requirements are necessary for compliance, the system provides a response preparation output in operation 602. Information regarding completion of the operation may be stored, for example, as indicted in operation 576.

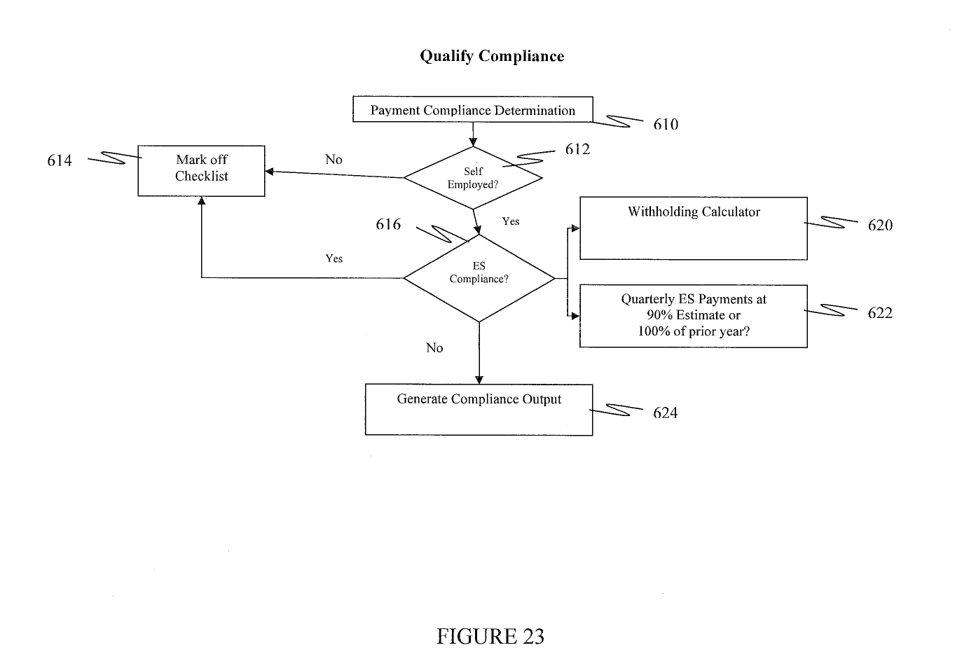

FIG. 23 illustrates various operations which may be performed in one example of qualifying payment compliance. In operation 610, the determination process is initiated. In operation 612, the system determines if the customer is self-employed. If the customer is not self-employed, information regarding completion of the operation may be stored, for example, as indicated in operation 614. If the customer is self-employed, the system determines whether the customer is making sufficient estimated tax (ES) payments in operation 616. For example, compliance may be determined based on a withholding calculator in operation 620, which may include an IRS or other calculator to determine proper withholding. Similarly, in operation 622, for example, compliance may be determined based on a whether quarterly ES payments are made at 90% of a customer's tax estimate or at 100% of the customer's prior year's tax return. If the system determines ES payments are sufficient, the system notifies the customer of ES compliance and documents compliance accordingly, for example, in operation 614. In operation 624, a compliance output is generated. For example, if the system determines that ES payments are not sufficient, output may include instructions on how to correct the deficiency, e.g., by increasing withholding/ES levels. The system may also explain implications in anticipating the ability to make IA payments. The system may also note special circumstances that could require unique treatment, e.g., IRA liquidation, for example. An IRS interview may also be used to supplement any of the above determinations.

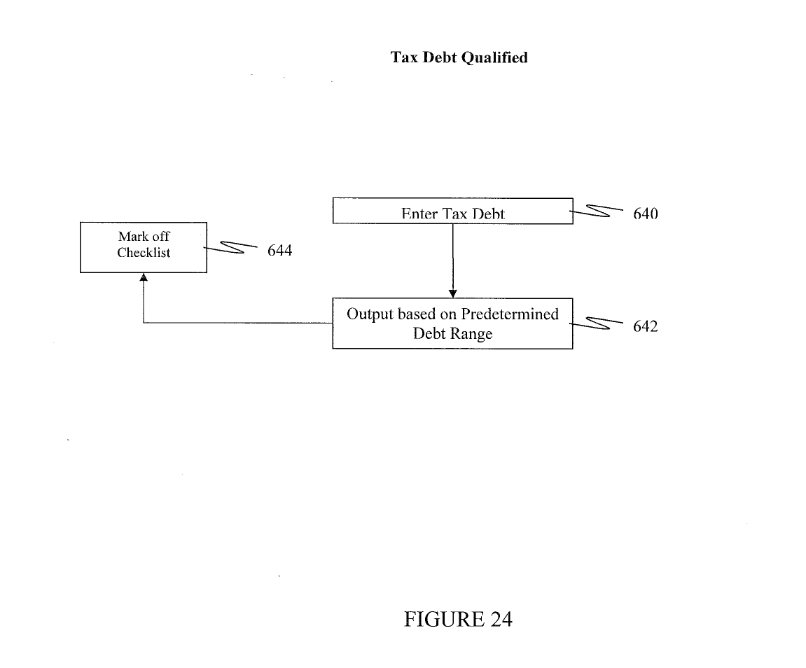

FIG. 24 illustrates various operations which may be performed in one example of qualifying tax debt. In operation 640, the system prompts the entrance of tax debt, for example, from a customer. In operation 642, the system provides at least one output based on a predetermined debt range. Predetermined debt ranges may be based on the appropriate agency regulations, for example. Output may be documented in operation 644.

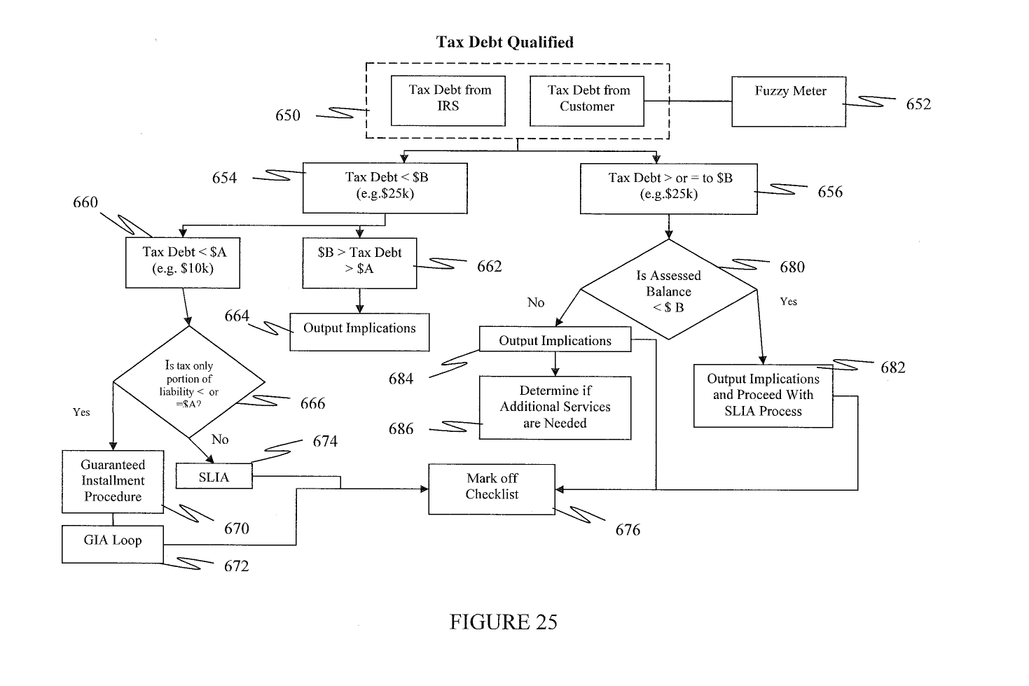

FIG. 25 illustrates various operations which may be performed in another example of qualifying tax debt. In operation 650, the system prompts the entrance of tax debt. Entrance may be based on tax debt obtained from the customer or the IRS. In operation 652, a fuzzy meter evaluates the entrance of tax debt for requisite certainty based on predefined parameters. Based on predetermined debt ranges, the process may proceed according to operation 654 or operation 656. Operation 654 is activated if tax debt is less than $B after all returns are filed and assessed. $B is debt threshold, above or below which procedural options may vary. For example, for 2008-2009, the IRS $8 is $25,000. Operation 656 is operated if tax debt is greater than or equal to $B.

If operation 654 is implemented, the system determines whether to implement operation 660 or 662. In operation 660, the system determines if tax debt is less than $A. $A is a debt threshold below $B, above or below which procedural options may vary. For example, for 2008-2009, the IRS $A is $10,000. In operation 662, the system determines if tax debt is less than $B and greater than $A. In operation 664, the system outputs implications if tax debt is less than $B and greater than $A. For example, at least one of: indicating that the IRS allows greater latitude when negotiating resolution of assessed balances less than $25,000; indicating that a resolution is available which does not require IRS managerial approval; indicating an opportunity to negotiate based upon the amount owed, rather than the financial situation; indicating that only limited information is required to be disclosed to the IRS, thus reducing the amount of work required to reach a mutually acceptable resolution; indicating that a customer may not be required to liquidate assets in order to pay the liability, thereby, allowing you to choose a more comfortable payment schedule; indicating that if a customer enters an agreement to pay the balance due through installments or by a certain time before the IRS files a lien, the IRS may choose not to file a lien, etc.

In operation 666, the system determines if tax liability is the only portion of liability less than or equal to $A. If yes, in operation 670, the system outputs a guaranteed installment agreement procedure and advantages thereof. The system may also execute a GIA loop for feasibility or output GIA tips to an SLIA solution as illustrated in operation 672. Exemplary outputs include at least one of: indicating that the IRS allows greater latitude when negotiating resolution of assessed balances less than $25,000; indicating a potential resolution available to you under which the IRS must allow the opportunity to pay the liability over a three year period and will not require liquidation of any assets and/or making a good faith payment as a prerequisite to agreeing to the resolution; indicating an opportunity to negotiate based upon the amount owed, rather than your financial situation, meaning, e.g., a customer will be required to disclose only limited information to the IRS; indicating that if the customer enters an agreement to pay the balance due through installments or by a certain time before the IRS files a lien, the IRS may choose not to file a lien, etc. If in operation 666, the system determines that tax liability is not the only portion of liability less than or equal to $A, the system initiates an SLIA output in operation 674. Completion of the appropriate output may be documented, e.g., in operation 674.

If operation 656 is implemented, in operation 680, the system determines if the assessed balance is less than $B. If the assessed balance is less than $B, in operation 682, implications are outputted and the system initiates a SLIA process. Exemplary output implications include at least one of: indicating that the IRS allows greater latitude when negotiating resolution of assessed balances less than $25,000; indicating that a resolution is available which does not require IRS managerial approval; indicating an opportunity to negotiate based upon the amount owed, rather than financial situation; indicating that you may not be required to liquidate assets in order to pay the liability; indicating an agreement to pay the balance due (through installment payments or to pay in full within a few months) before the IRS filed a tax lien, may result in the IRS not filing a lien.

If the assessed balance is greater than $B, in operation 684, implications are outputted. Outputs may include at least one of: indicating that resolution will likely require IRS managerial approval; indicating that one possible exception to IRS managerial approval is a short extension in order to pay the liability in full; indicating that resolution will likely be based upon financial situation, and that more detailed financial information might need to be disclosed to the IRS; indicating that asset liquidation may be required in order to pay the liability in full or in part; indicating that IRS “Allowable Living Standards” may be a factor in the resulting resolution. In operation 686, an additional services determination may be made, e.g., a determination whether lien strategy services are needed.

If assessed balances are not available, outputs may include, for example, at least one of: indicating that the IRS allows greater latitude when negotiating resolution of assessed balances less than $25,000, and that a more detailed analysis may indicate that the assessed balance is actually under the $25,000 threshold; indicating that if the assessed balance is greater than $25,000, then one of the implications is that resolution will likely require IRS managerial approval (with the possible exception of a short extension in order to pay the liability in full); indicating that if the assessed balance is in excess of $25,000, resolution will likely be based upon financial situation, meaning increased and/or more specific disclosure of financial information to the IRS; indicating that liquidation of assets may be required in order to pay the liability in full or in part; indicating that IRS “Allowable Living Standards” may be a factor in resolution; indicating that market intelligence indicates that if the assessed balance exceeds $25,000, it is likely that the IRS will file a Federal tax lien; indicating that a lien may be filed before, during or after negotiation with the IRS; indicating that an “implied lien” already exists”; indicating selection of lien strategy services, e.g., the system's Lien Strategy Center, etc.

Referring back to FIG. 19, alternate solutions 544, in addition to SLIA, may also includes any of paydown and then SLIA; IA based on ability to pay; conditional IA; lifestyle IA; CNC; lien services; PPIA; OIC; and interim agreement until assessment is corrected.

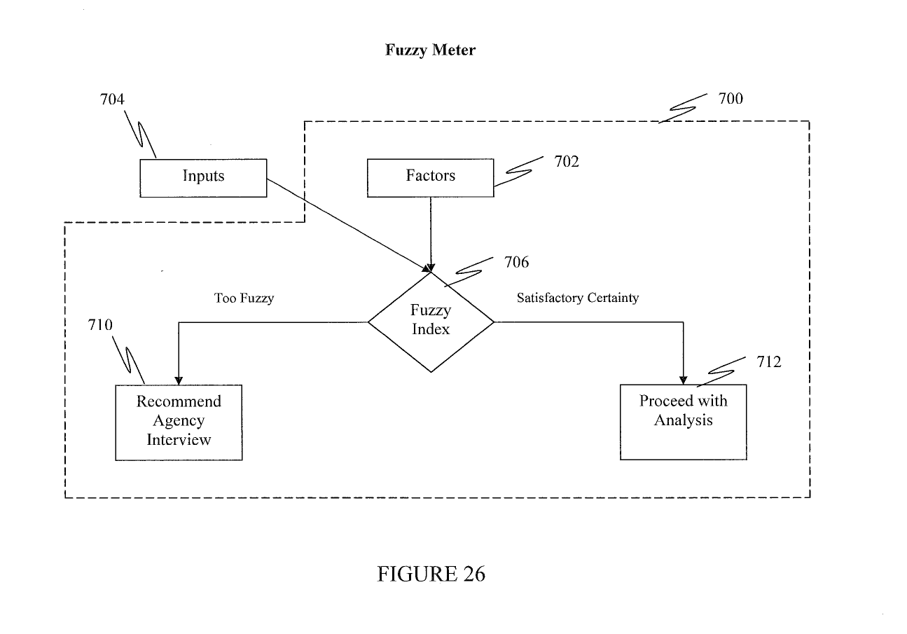

Fuzzy meters, e.g., as illustrated at 652 in FIG. 25, are useful in a variety of the operations disclosed herein for building a “fuzziness” index to allow the system to determine whether or not to recommend an IRS interview. FIG. 26 illustrates operations performed by one embodiment of a Fuzzy Meter 700. In index operation 706, inputs 704 are compared against predetermined factors having relative indicator values 702 to determine if certainty is satisfactory. If the inputs are too fuzzy, the system recommends an agency interview, as in operation 710 to increase certainty. If the inputs have satisfactory certainty, the system may proceed with the appropriate operation, e.g., debt analysis, as in operation 712. Table 13 illustrates exemplary factors, methods for generating inputs, and relative value indicators. These may vary from solution to solution or from output to output as needed.

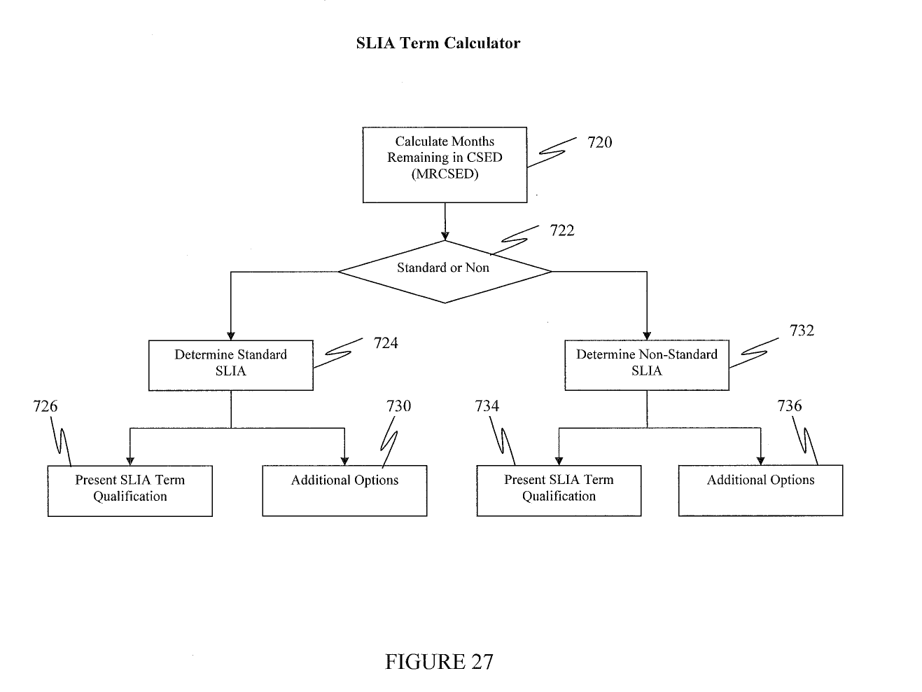

FIG. 27 illustrates various operations that may be performed when calculating SLIA term according to one embodiment. In operation 720, the system calculates months remaining (MR) in the collection statute of expiration date (CSED). In operation 722, the system determines whether a standard or non-standard SLIA is needed. If a standard SLIA is determined, in operation 724, the system determines the SLIA. In operation 726, the system presents the SLIA term qualification to the customer. In operation 730, the system presents additional options. If a non-standard SLIA is determined, in operation 732, the system determines the SLIA. In operation 726, the system presents the SLIA term qualification to the customer. In operation 730, the system presents additional options. Table 14 illustrates exemplary term calculations.

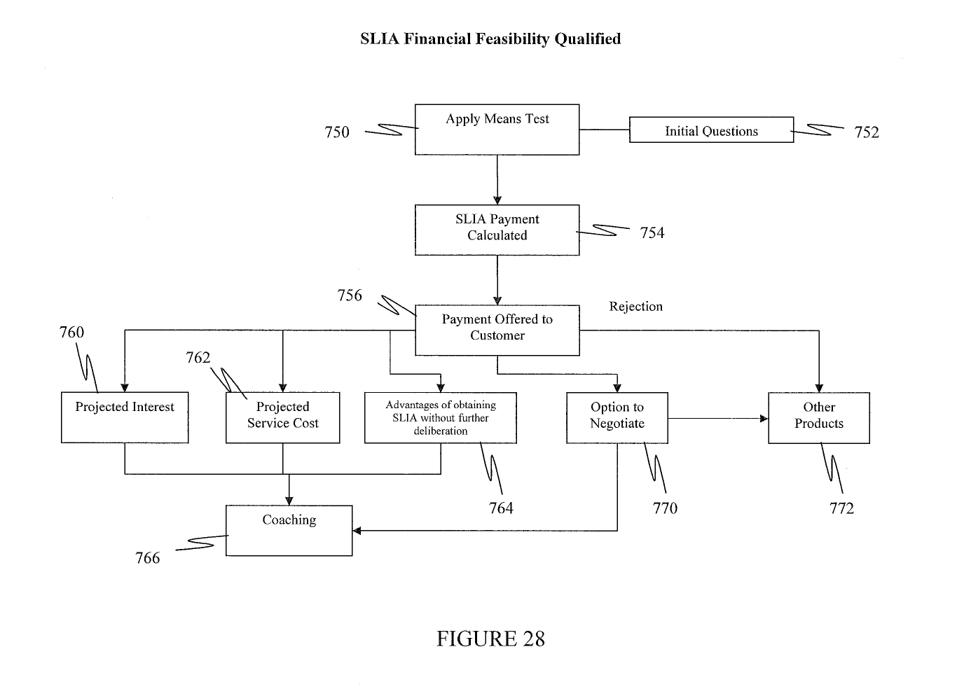

FIG. 28 illustrates various operations that may be performed when qualifying SLIA financial feasibility according to one embodiment. In operation 750, the system applies a means test. Operation 750 may be based on, for example, initial questions 752. Initial questions may include, for example, gross annual or monthly income, residence location, and number in family. The system may calculate the ratio of GMI to maximum Allowable Living Expenses (ALEs) based information provided. The system may also prioritize recommendations based on financial feasibility. For example, if GMI minus ALEs is greater than or equal to recommended SLIA payment calculated, the SLIA may be rated highly or as the highest recommended solution. In operation 754, SLIA payment is calculated. For example, the system may divide the balance due by SLIA term to calculate recommended SLIA payment. In operation 756, the payment option is offered to the customer. The offer may illustrate that the current payment option is based on at least one of the ratio of GMI to ALE, SLIA term, tax debt level, and likelihood of IRS acceptance of the proposed. The option offered may also include providing at least one of: present projected interest in operation 760, present cost to hire representation to perform services in operation 762, present advantages of obtaining an SLIA without further deliberation in operation 764. The option offered might also include presenting an option to proceed with negotiating the resolution in operation 770. If any of operations 760, 762, and 764 are implemented, the system implements coaching in operation 766. The system may also advise that penalty abatement opportunities will be considered once the resolution has been chosen. If a customer rejects the proposed offer, the system will determine other suitable solutions or products in operation 772, for example a full resolution investigation including at least one of present timeline, probabilities based upon known information, comparison costs of hiring a firm to pursue these options, etc.

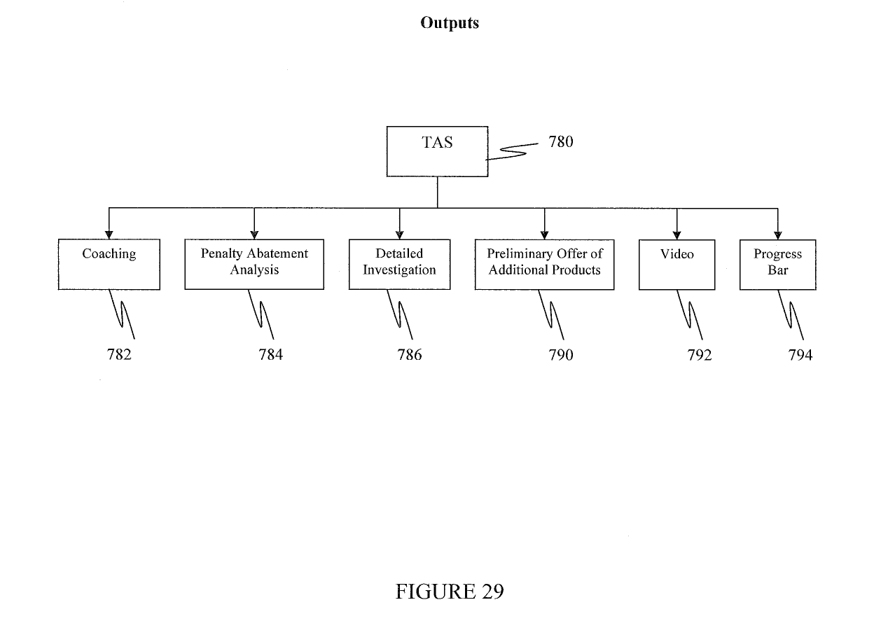

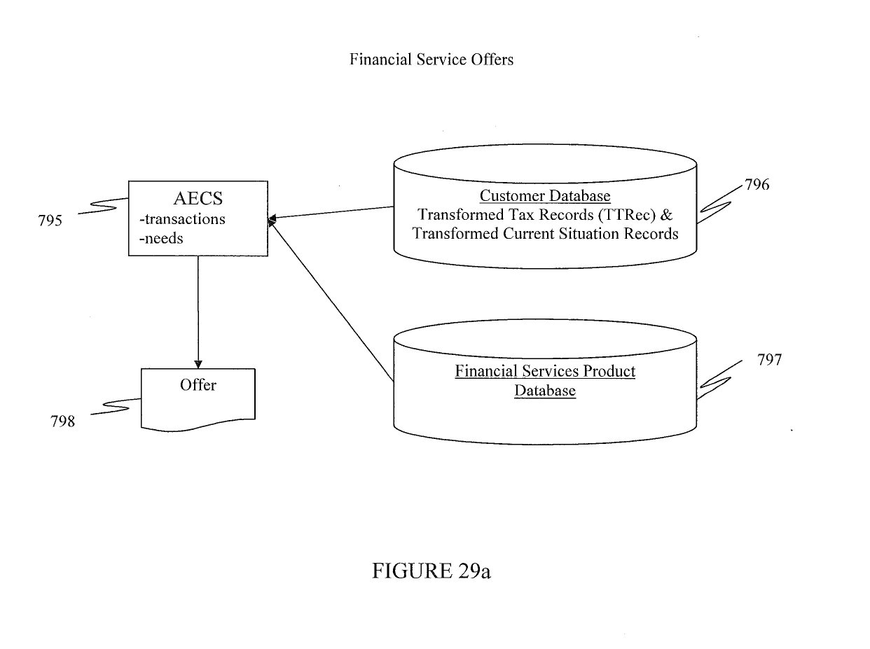

FIG. 29 illustrates some outputs that may be provided when using a TAS process 780, e.g. an SLIA process or some other process. Coaching output 782 may include any of: general tips; summary of customer situation; initial agency disclosures required; compliance requirements; compliance issues; resolution-specific disclosures to be made; resolution-specific points of negotiation; timeline tips, e.g. how much time the user can obtain to pay given the facts, dead-line tracking, etc.; document preparation tips; document submission tips; follow up tips, etc. Penalty abatement analysis output 784 includes any form of document or communication preparation to avoid penalties. Detailed Investigation output 786 may include at least one of providing an overview of potential advantages to further investigation; providing timeline ranges for each identified potential resolution; provide success probability of each identified potential resolution; providing prices relative to further investigation, etc. Preliminary offer of additional products output 790 may include any of the other products listed herein or additional products, with offers made, for example, based on information contained within a TAS database. Additional products may include additional financial products, e.g., related to banking, credit, investments, real estate, loans, insurance, record keeping services, etc. Video output 792 may be a prerecorded video presentation of information similar to coaching output. Progress bar output 794 may be used to show a customer's progression through the process. Although the outputs are described in terms of some SLIA outputs, other solutions may have similar, or additional, outputs. Further, other SLIA outputs include the outputs previously mentioned, e.g., reports and interviews.

FIG. 29a illustrates one example of a system generating outputs including offers of financial services. In this example, AECS portion 795 analyzes customer information contained in a database, e.g., 796. Database 796 may contain any variety of information from any variety of sources, for example, any information retrieved by RCS such as transformed tax records (TTRec) or transformed current situational records (TCSRec). Database 796 may also contain other information, e.g., customer preferences, updated profile information, etc. The AECS can process information in database 796 looking for recent or upcoming transactions and recent or upcoming needs. For example, AECS may look for transactions related to real estate, children, investments, mortgages, other liabilities, etc. AECS may also look for needs related to savings, life events, loans, etc. Based on any combination of transactions or needs, AECS may generate an output 798 in the form of an offer of financial services. Financial services offered may be provided by any number of third-parties, and offers may include a contact to the offering third-party, e.g., a hyperlink.

In one example, information contained in database 796 indicates that a customer has outstanding tax dept. AECS determines that the customer has insufficient liquidity to cover the debt and determines that a loan to cover the tax debt is a viable option. In offer 798, the system offers third-party loan services to the customer based on an agreement between the third-party and the system service provider.

In another example, information contained in database 796 indicates that a customer has a 19 year old, dependent, full-time student. AECS determines that a loan, e.g. to cover student debt, is a viable option. In offer 798, the system offers third-party student loan services to the customer based on an agreement between the third-party and the system service provider.

In another example, information contained in database 796 indicates that a customer has high medical expenses. AECS determines that health insurance is a viable option. In offer 798, the system offers third-party health insurance to the customer based on an agreement between the third-party and the system service provider.

In another example, information contained in database 796 indicates that a customer has a high AGI, e.g. above a predefined threshold AGI. AECS determines that the customer has no home ownership and that a real estate purchase may be a viable option. In offer 798, the system offers real estate to the customer based on customer location.

Other examples are readily apparent based on the teachings herein.

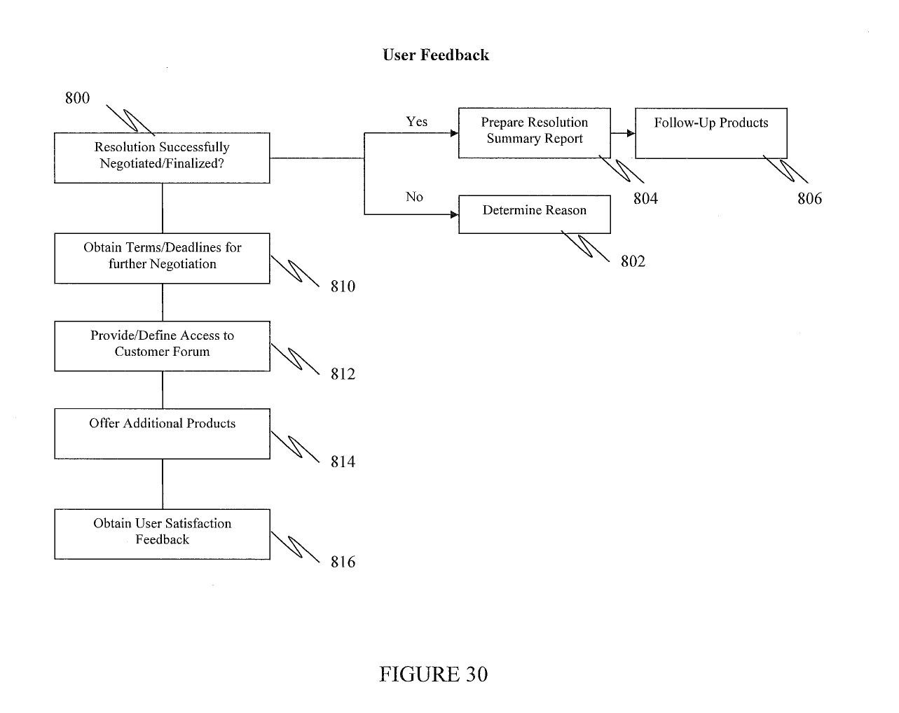

FIG. 30 illustrates various user feedback operations that may be used in a TAS system according to one embodiment. In operation 800, the system determines if resolution was successfully negotiated or finalized. If yes, the system may prepare a resolution summary report in operation 804. The summary report may include education of additional benefits available (member forums, etc.). In operation 806, the system may also provide preliminary offers on follow-up products. If the system determines that resolution was not successfully negotiated or finalized, it will determine the reason in operation 802. In operation 810, the system obtains term and/or deadlines for further negotiation. In operation 812, the system provides and/or defines access to the customer forum. Customer forums may vary from example to example. In many examples, the forum may be organized as a web-based chat page, whereby customers can discuss opinions, concerns, pointers, etc. in regarding to various aspects of the system. For example, forums may be organized to allow customer to readily search, discuss, and comment on any of the variety of outputs produced by the system. Forums may similarly be arranged to allow customers to readily search, discuss, and comment on agency actions, e.g., based on agency form letter number or subject. In operation 814, the system offers additional products. In operation 816, the system obtains user satisfaction feedback.

As illustrated, user feedback may be used in a variety of ways. For example, it may be organized or exported from customer forums, e.g. 812, according to problems or goals, to allow members to evaluate the resolution outcomes and IRS current operations experienced by others. Further, the TAS system, e.g., the analysis engine, may modify outputs or products based on customer feedback. For example, if an analysis engine or TAS service provider determines that a solution option X has a decreased success rate relative to a solution option Y, the analysis engine may prioritize solution option Y over solution option X. Similarly, an analysis engine or TAS service provider may develop new solution options based on user feedback. For example, products 806 or 814 may be considered additional products developed by an analysis engine or TAS service provider based on user feedback. Illustrative examples are provided below:

### Example 1

TAS User A will complete the penalty relief section of TAS application. User A will find out that the IRS will abate all failure to pay penalties with a full payment of the liability. User A will post this new information to a TAS forum that is accessible to other TAS users. Other users, e.g., those accessing the penalty relief service section, can see User A's tip for their use. TAS modifies the application to allow for this change in IRS procedure.

### Example 2

TAS User B uses TAS system to provide feedback that the IRS has removed one of the letters in its collection process and, thus, shortened the collection process. Analysis engine modifies content and the response system to note that this letter may be removed from the collection cycle.

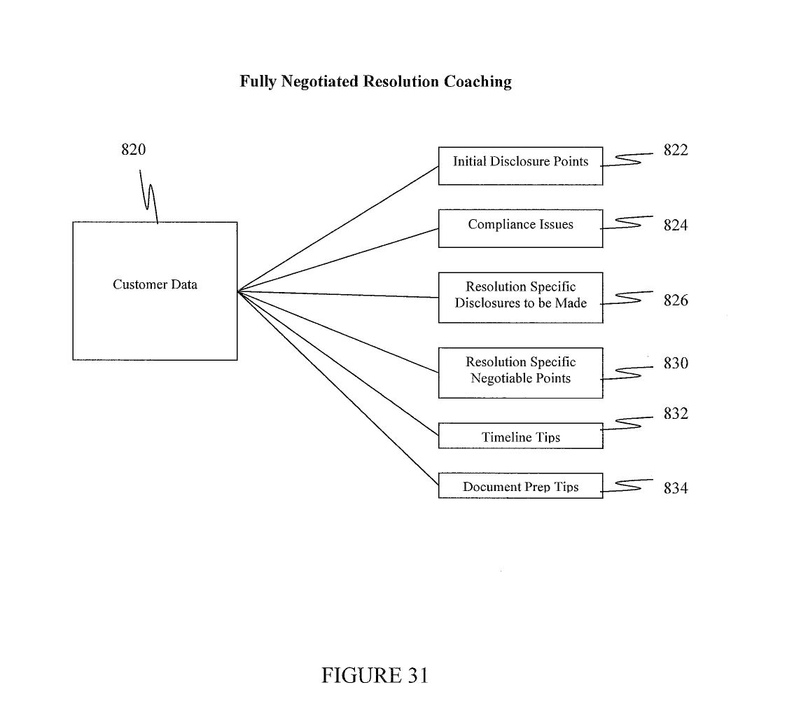

FIG. 31 illustrates various coaching operations that may be used in a TAS system according to one embodiment. Customer data 820 may be analyzed against other information in the database, e.g., tax agency rules, regulations, procedures, strategy success probability, etc., to provide guidance to the customer. For example, guidance may include at least one of determining initial disclosure points in operation 822; determining compliance issues in operation 824; determining resolution specific disclosures to be made in operation 826; determining resolution specific negotiable points in operation 830; determining timeline tips in operation 832; determining document preparation tips in operation 834, etc. Determined information may also be considered to be supplied to the customer. Such coaching operations may be particularly useful, for example, in SLIA solutions, or other solutions.

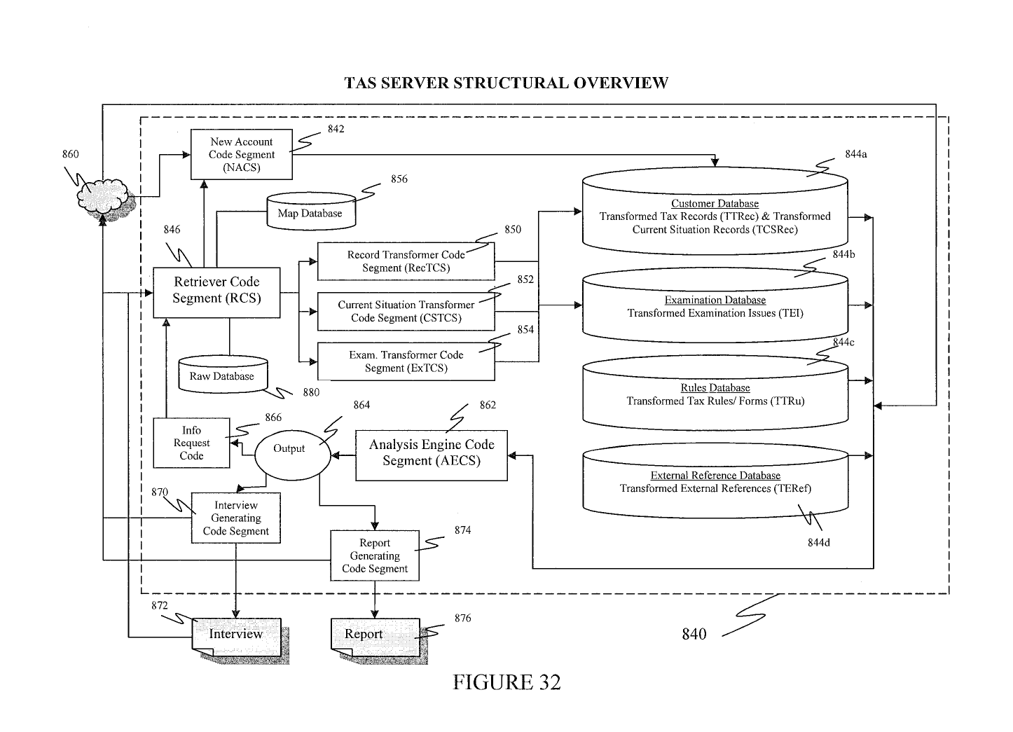

FIG. 32 illustrates the structure and interaction of components in another embodiment of a TAS server. Sever 840 includes new account code segment (NACS) 842 in communication with databases 844a, 844b, 844c, and 844d. Retriever code segment (RCS) 846 is in communication with NACS 842 and transformer code segments 850, 852 and 854. RCS 846 is also in communication with Map Database 856. In operation, information retrieved by the RCS via the Internet/network 860 is classified or typed based on information contained in map database 856. Based on typing, information is sent to the appropriate transform code segment where it is transformed and sent to the appropriate database. Record Transformer Code Segment (RecTCS) 850 is for transforming customer records. Current Situation Transformer Code Segment (CSTCS) 852 is for transforming customer situational data. Examination Transformer Code Segment (EcTCS) is for transforming examination issues, e.g., issues pointed out by a tax agency in an examination. In this depiction, RecTCS 850, CSTCS 852 and ExTCS 854 are in communication with customer database 844a and examination database 844b. Customer database 844a contains transformed tax records (TTRec) and transformed current situation records (TCSRec). Examination database 844b contains transformed examination issues (TED. Rules database 844c contains transformed tax rules and optionally forms (TTRu). External reference database 844d contains transformed external references (TERef). Databases, e.g. the rules database and external reference database may be in communication with Internet/network 860, for example, to facilitate database population. In some situations, customer databases and examination databases may also be in communication with Internet/network 860 to supplement population. Rules and external references may be transformed manually for database population or by using the appropriate code segment on a server or other computer terminal. RCS 846 may also be in communication with raw database 880, which contains raw images and data retrieved by the RCS.

Engine code segment (AECS) 862 is in communication with databases 844a, 844b, 844c, 844d; with RCS 846; and with Internet/network 860. AECS 862 generates an output 864 that may be utilized by a variety of code segments. For example, output 864 may be used by info request code 866 to request that additional information be retrieved by RCS 846, for example, additional information from a customer or a raw database, etc. Output 864 may be used by interview generating code segment 870 to generate interviews for at least one of an agency and a customer. Interviews may be sent electronically, e.g., through Internet/network 860 to a customer computer, or they may be converted to hard copy for mailing, e.g., interview 872. Output 864 may be used by report generating code segment 874 to generate customer reports. Reports may be sent electronically, e.g., through Internet/network 860 to a customer computer, or they may be converted to hard copy for mailing, e.g., report 876. Report generating code segment 872 may also be the location where coaching operations discussed previously are performed. Report generating code segment may also send notices of upcoming agency deadlines, for example, based on information contained in TTRu 844c regarding required response times or response times that dictate procedural changes. Notices may be sent similar to other types of reports, e.g., electronically or by paper.

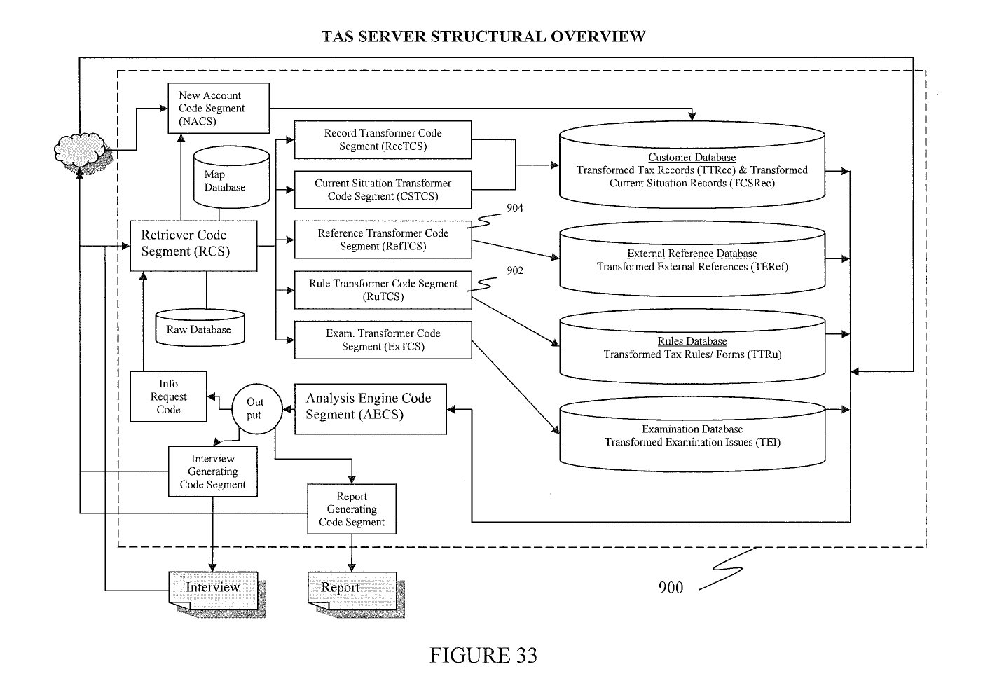

FIG. 33 illustrates another embodiment of a TAS server 900, which is similar to the server illustrated in FIG. 32. Server 900 also includes Rule Transformer Code Segment (RuTCS) 902 and reference transformer code segment (RefTCS) 904 for transforming, at least in part, information contained in the external reference database and the rules database.

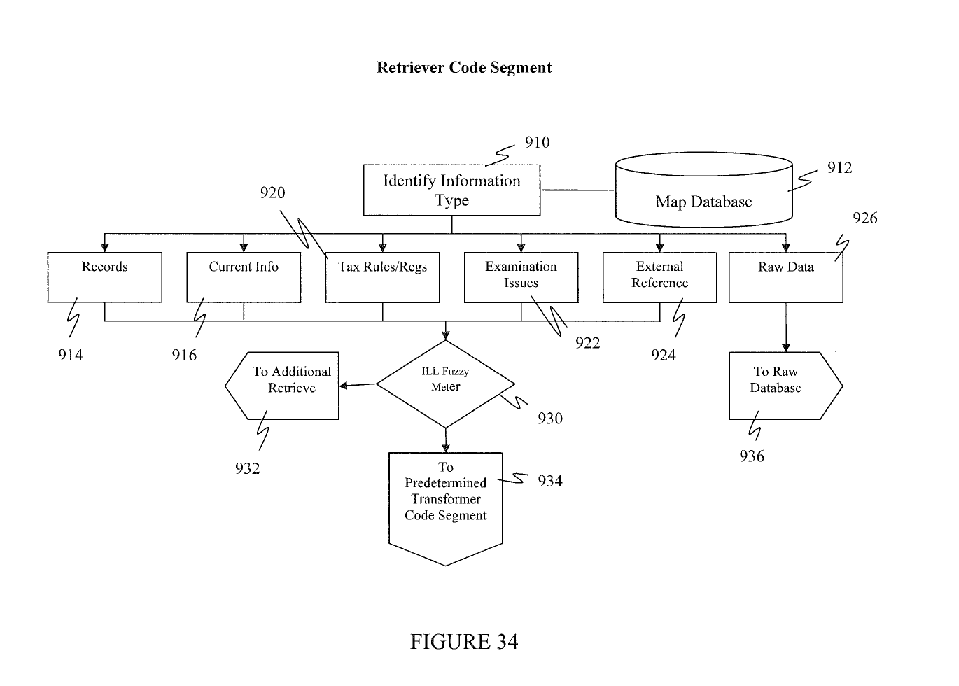

FIG. 34 illustrates various RCS operations that may be used in a TAS system according to one embodiment. In operation 910, information is identified based on type. In the embodiment shown, information is classified or typed based on data and indicia contained in map database 912. For example, information may be classified as customer records 914, current situational information 916, tax rules, laws, regulations and procedures 920, examination issues 922, external references 924, or raw data 926. For certain types of information, it may be necessary to achieve a particular level of certainty regarding the accuracy of the information. For example, customer records 914, current situation info 916, examination issues 922, etc, may optionally be run through identifying information logic (IIL) fuzzy meter 930 to determine if certainty is sufficient. IlL fuzzy meter 930 may operate similarly to fuzzy meters described above. If certainty is not sufficient, an additional retrieve may be performed as illustrated in operation 932. If certainty is sufficient, the classified information may be sent to a predetermined transformer code segment, e.g., one of those mentioned above. Some types of information may be sent the requisite database without requiring a fuzzy logic operation. For example, raw data 926 may be sent to a raw database in operation 936 without performing a fuzzy logic operation.

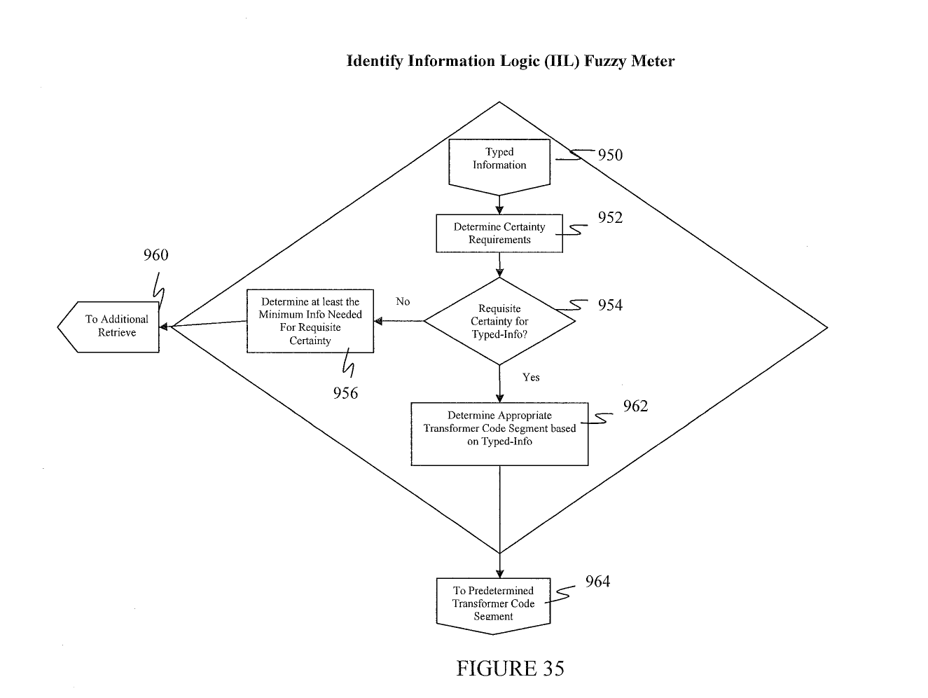

FIG. 35 illustrates various ILL fuzzy meter operations that may be used in a TAS system according to one embodiment. In operation 950, classified or typed information comes to the fuzzy meter, this information may be typed for example using operation 910 described above, or some other operation. In operation 952, certainty requirements are determined for the typed information. In operation 954, the system determines whether the requisite certainty for the typed information has been met, using, for example, an index creator as described above. If the requisite certainty has not been met, in operation 956, the system determines a minimum amount of information needed for requisite certainty. The system may then perform an additional retrieve, e.g., an agency or customer interview, to gather the requisite information. If the requisite certainty has been met, in operation 962, the system determines the requisite transformer code segment based on the typed information. In operation 964, the information is sent to the appropriate transformer code segment.

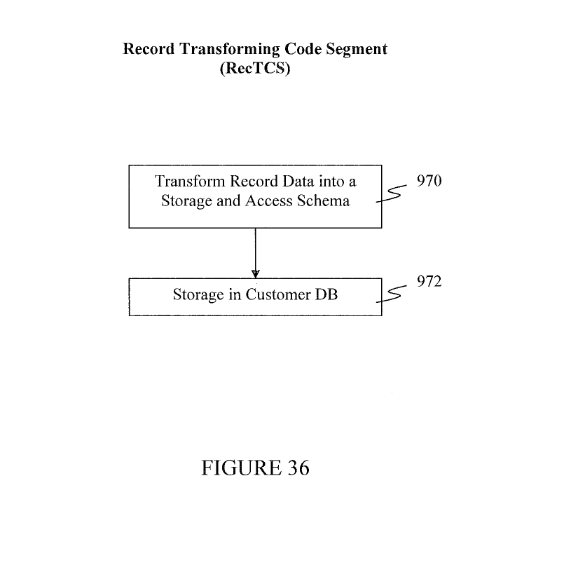

FIG. 36 illustrates operations performed by one embodiment of record transforming code segment (RecTCS). In operation 970, record data is transformed in to a storage and access schema. In operation 972, the transformed data is stored in the customer database.

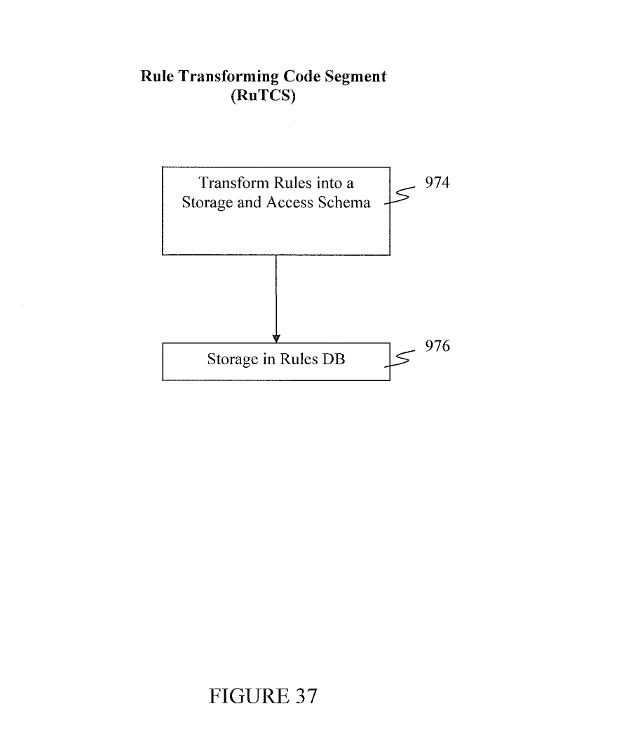

FIG. 37 illustrates operations performed by one embodiment of rule transforming code segment (RuTCS). In operation 974, rules, regulations and procedures are transformed in to a storage and access schema. In operation 976, the transformed data is stored in the rules database.

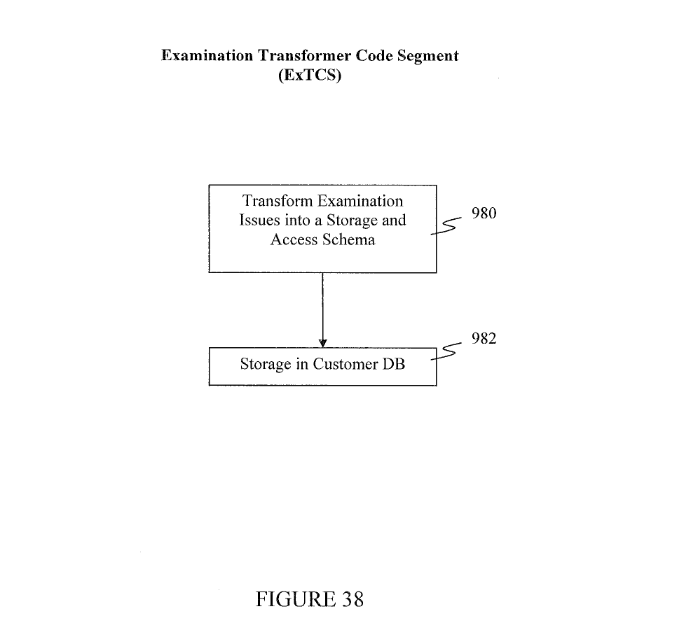

FIG. 38 illustrates operations performed by one embodiment of examination transforming code segment (ExTCS). In operation 980, examination issues are transformed in to a storage and access schema. In operation 982, the transformed data is stored in the examination database.

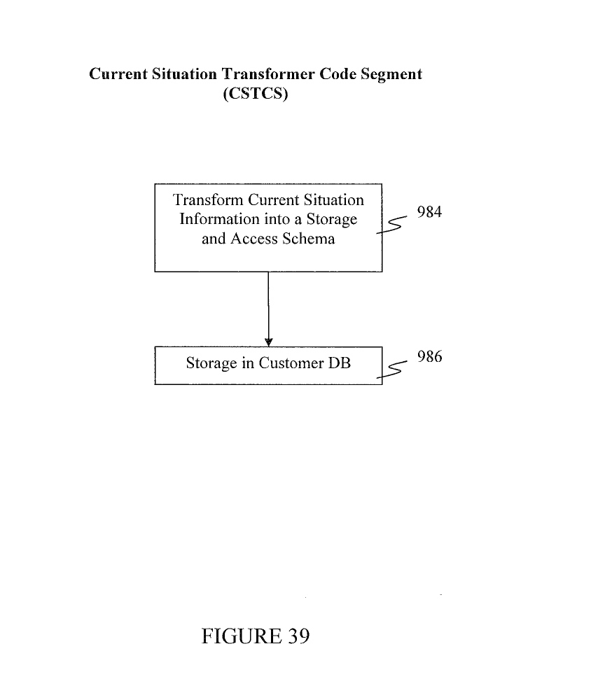

FIG. 39 illustrates operations performed by one embodiment of current situation code segment (CSTCS). In operation 984, customer current situational information and issues are transformed in to a storage and access schema. In operation 986, the transformed data is stored in the customer database.

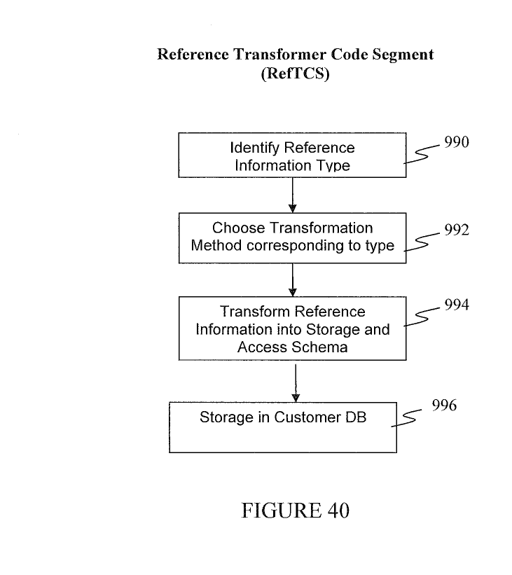

FIG. 40 illustrates operations performed by one embodiment of reference transformer code segment (RefTCS). In operation 990, reference transformer code segment identifies the reference information type. For example, reference information may include credit scores, asset values (e.g., the KELLY BLUEBOOK values), statistics on various tax debt negotiations, etc. In operation 992, a transformation method is chosen based on type of reference information. In operation 994, typed reference information is transformed into storage and access schema. In operation 996, transformed information is stored in an external reference database.

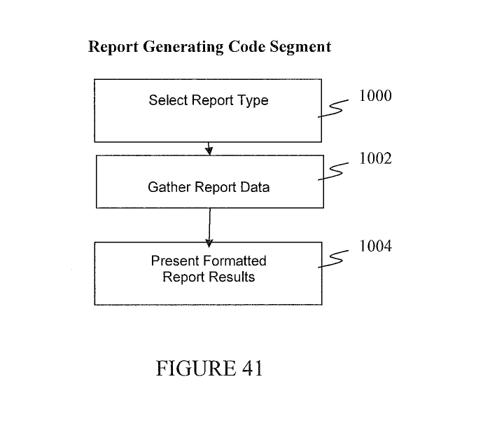

FIG. 41 illustrates operations performed by one embodiment of report generating code segment. In operation 1000, report type is selected. For example, reports may include any electronic analysis of the agency tax examination. As noted previously, reports may be submitted in electronic, as well as, paper format. In operation 1002, report data is gathered. In operation 1004, report results are formatted and presented.

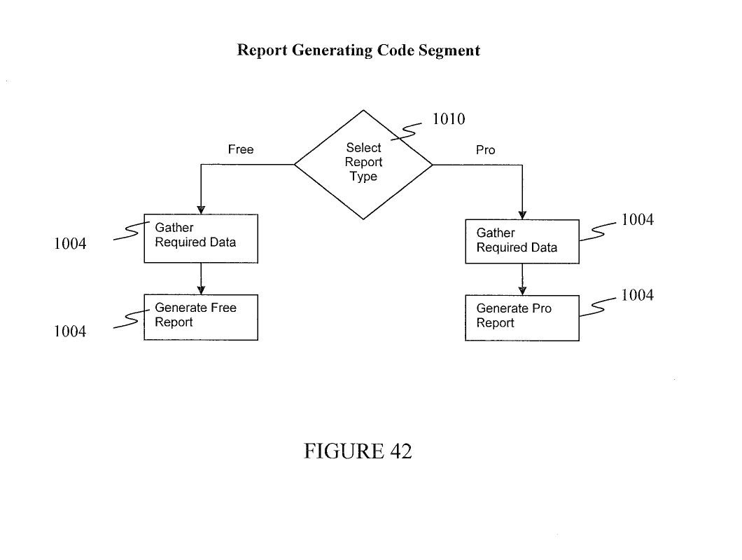

FIG. 42 illustrates operations performed by another embodiment of report generating code segment. In operation 1010, a report type is selected. Reports may be similar to any of those described above. In operation 1002, report data is gathered. In operation 1004, report results are formatted and presented.

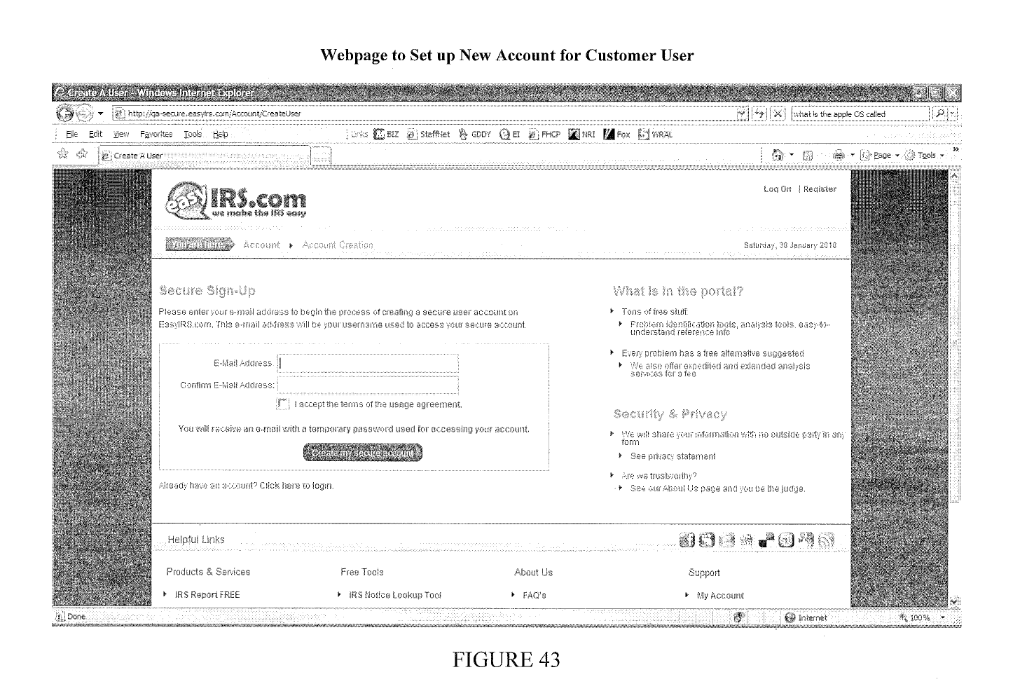

FIG. 43 illustrates one embodiment of a web portal or interface for secure sign up.

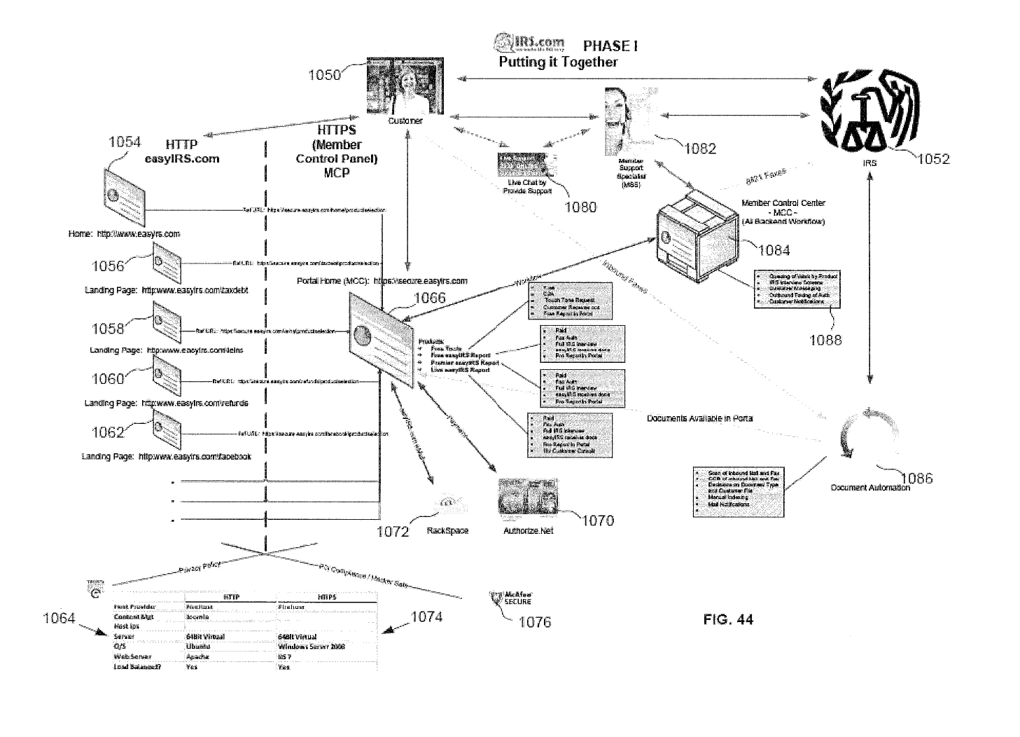

FIG. 44 illustrates an overview of one embodiment of a TAS in operation. In this example, customer 1050 has received notice of examination from tax agency 1052, e.g. the IRS. Customer 1050, using a customer computer, goes to web portal 1054. Web portal 1054 is a customer interface generated, for example, by a NACS. A variety of other web portals are also generated by the TAS, for example, landing page 1056 summarizing tax debt issues; landing page 1058 summarizing lien issues; landing page 1060 covering refunds, and landing page 1062, which may actually redirect customers to a home page from another website, e.g., from FACEBOOK, etc. As illustrated in descriptor 1064, in this embodiment, the host provider is FireHost, content management is performed by Joomla, the server is a 64 Bit Virtual, the operating system is Ubuntu, and the web server is Apache. The above portals provide the requisite customer privacy.

At portal 1054, the TAS creates a new account for customer 1050 in part by collecting her name and email address. Once an account has been created for customer 1050, customer 1050 can access secure system portal 1066. From secure portal 1066 customer 1050 has access to products including free tools, e.g., a free agency report. A free agency report may include, for example, C2A, touch tone requests, sending an OCS to the customer, and generating a free report in the portal. Customer 1050 may also choose to access premium services, e.g. a premium agency report or a live agency report. Premium services may be accessed, for example, by payment 1070 over the portal. Premium services may include faxed agency authorization, a full agency interview, system retrieval of documents, and the generation of a premium report. Live agency reports may also include live customer consultation 1080 with specialist 1082.

Reports and other services may be provided to customer 1050 via the portal or via email 1072 for example. As illustrated in descriptor 1074, in this embodiment, the host provider is FireHost, the server is a 64 Bit Virtual, the operating system is Windows Server 2008, and the web server is IIS 7. The above portal provides PCI compliance and is hacker safe. Additional products, e.g., McAFEE SECURE 1076 may also be used to supplement security.

Portals described above are generated by TAS server 1084. TAS server 1084 also manages operations 1086, e.g., scanning of inbound mail and faxes; OCR of inbound mail and faxes; decisions on document type and customer file; manual indexing, and mailing notifications. TAS sever 1084 may also manage operations 1088, including queuing of work product; generation IRS interview screens; sending customer messaging; faxing of agency authorization forms; and generation of customer notifications.

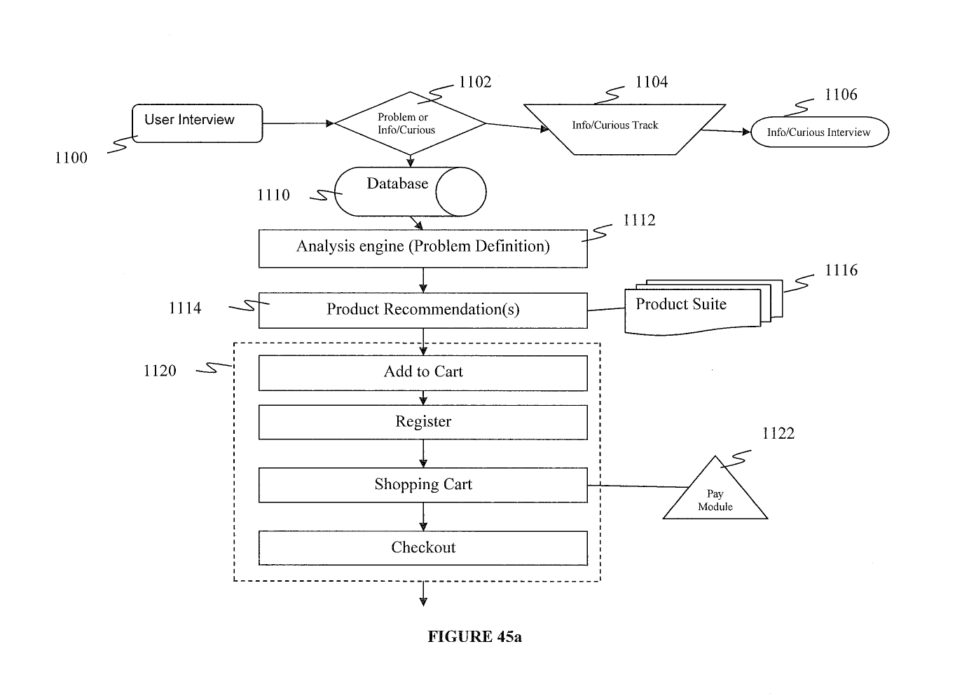

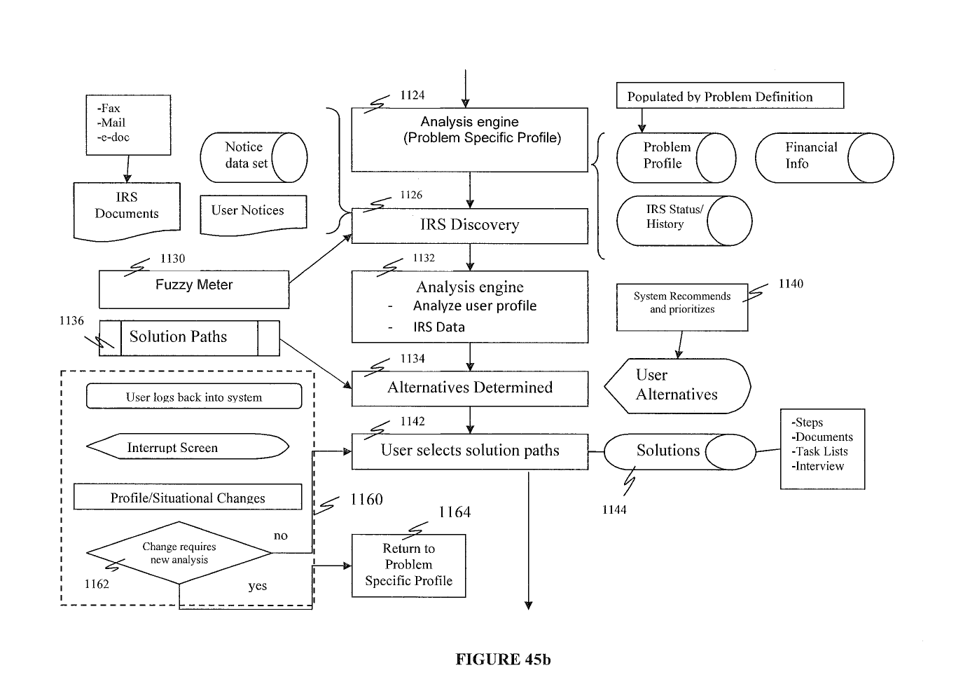

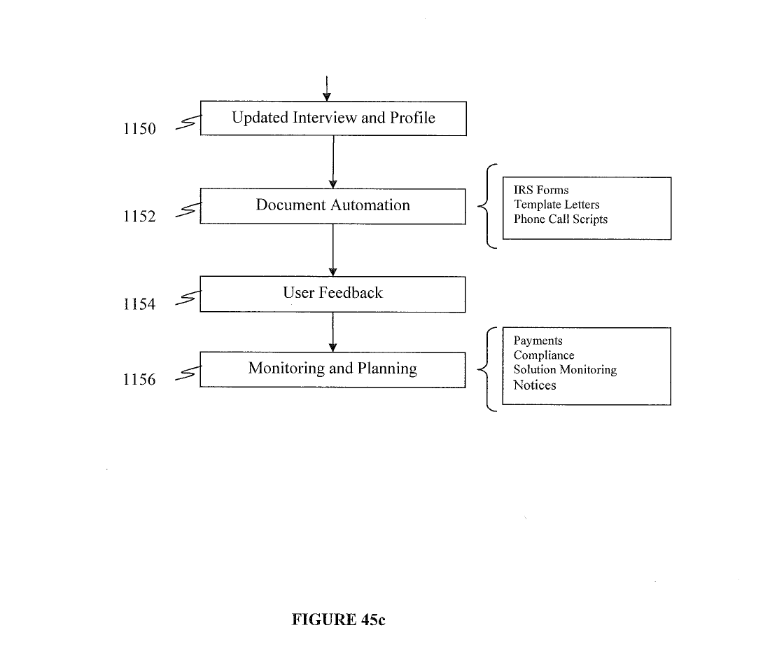

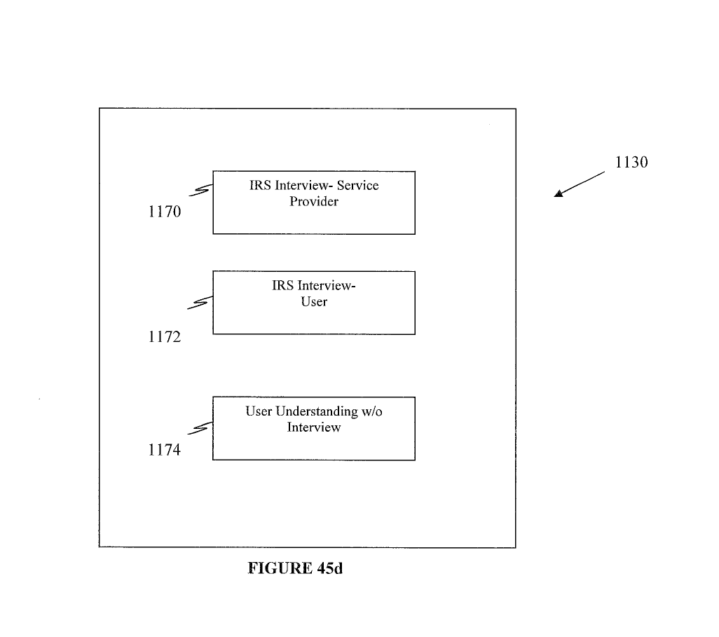

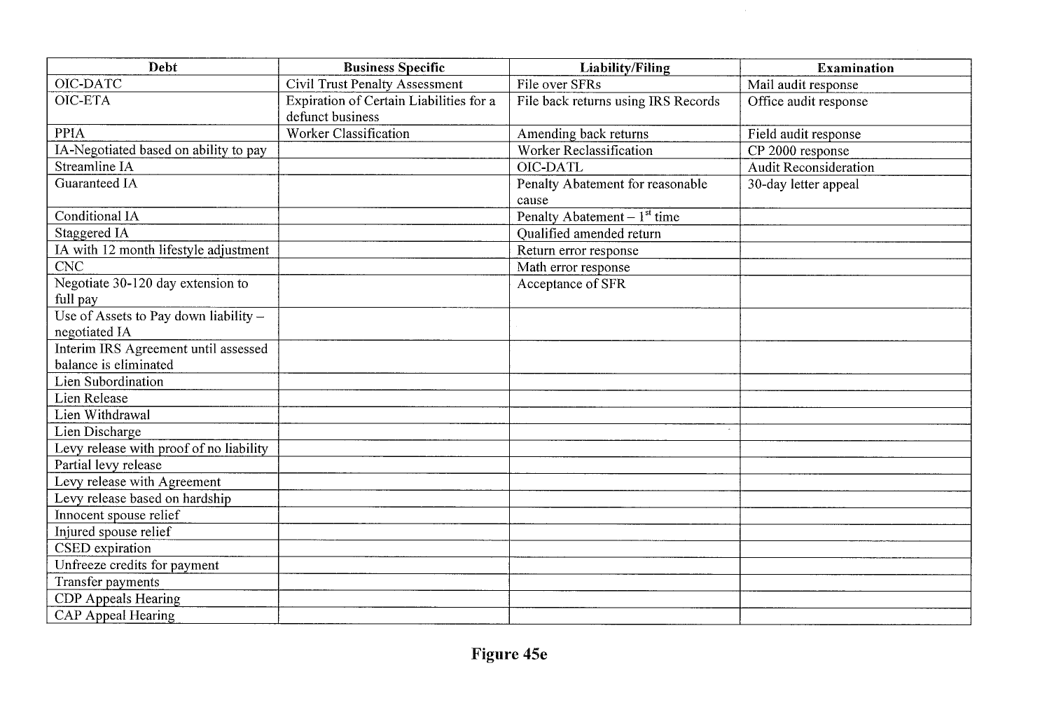

FIGS. 45a, 45b, 45c, and 45d provide another example of a tax system, as described herein, in operation. Referring primarily to FIG. 45a, in operation 1100, the system initiates a user interview. The user interview may include, for example, a website interface for a customer, which may be generated by an output code segment. In operation 1102, the system determines whether the user has an actual problem or is requesting information/curious about the system, for example using a retriever code segment (RCS). If the user is requesting information or just curious, the system initiates operation 1104 and may additionally perform an interview in operation 1106.

If the user has a problem, e.g. their tax return is being examined and they are seeking the assistance of the system, the system employs operation 1110 and populates a database, e.g. a customer database. For example, a RCS may retrieve high level information about the customer situation from high level questions displayed on a customer interface. The system may then transform answers to those questions using transformer code segment (TCS) to populate the database. In operation 1112, the system uses analysis engine code segment (also called analysis engine) to define the problem (or create a problem definition). The problem definition may be created using, for example, a decision tree to group problems into one of any number of areas. For example, product definitions may include those illustrated in operation 332 in FIG. 13. Based on the problem definition, the system may then recommend a product in operation 1114. Products may be selected from product suite 1116, which may include for example, a very comprehensive analysis (e.g. for businesses having a variety of assets and loan obligations), a basic analysis, a simple analysis, a free analysis, etc. Users may then select the desired product in operation 1120 or indicate if the recommended product is acceptable. Selection may include a single or any series of steps including, for example, adding the selected product to an electronic cart, registering the product, returning to the shopping cart for payment, e.g. using pay module 1222, and checking out.

Operations after selection 1120 proceed on FIG. 45b. In operation 1124, the analysis engine establishes a problem specific profile, determining what information is needed for implement the selected solution. In performing this operation, the analysis engine may consult various databases including various types of information, e.g., a problem profile database populated by a problem definition, financial information, IRS status/history, etc.

If the analysis engine determines there is insufficient information to populate the problem specific profile, in operation 1126 the analysis engine will conduct discovery to obtain additional information. Discovery may include any of IRS documents, notice data sets, user notices, etc. Discovery may be performed by RCS or interview generating code segment, for example. In operation 1130, a fuzzy meter may used to evaluate information obtained, for example, from IRS discovery operation 1126. One example of a fuzzy meter is shown in more detail in FIG. 45d, discussed below.

In operation 1132, the analysis engine may analyze user data with IRS data to look for inconsistencies between the two data sets. If inconsistencies are discovered, the analysis engine may seek input for clarification, e.g. it may generate an output request for more definite information, or it may make an internal evaluation as to which type of information has a higher inherent degree of certainty.

In operation 1134, the system determines available alternative solutions. Alternative solutions may be based on a variety of solution paths 1136. FIG. 45e illustrates exemplary solution paths categorized based on debt, specifics to a particular business, liability, and examination specifics. Solution paths may be categorized in any number of ways. Alternatives 1134 may also be based on user alternatives, e.g. alternatives desired by the user, which may be prioritized with recommendations in operation 1140. Table 16 Illustrates examples of the system using user goals to dictate product recommendations, including the prioritization of recommendations. In operation 1142, the user selects the solution path based on alternatives determined. For each solution path, at least one database 1144 contains data related to steps, rules, documents, forms, task lists, interview information, etc. to be used by the analysis engine for implementing the solution.

Proceeding to FIG. 45c, in operation 1150, the analysis engine may update the user profile after solution selection has been made. This operation may similarly include an updated interview for the user or the tax agency to supplement any additional information needed to implement the specific solution. In operation 1152, the system may produce documents based on the selected solution, for example, tax agency forms, template letters, phone call scripts, etc., needed to implement or facilitate the solution.

In operation 1154, the system may request user feedback. For example, the system may inquire as to whether the selected solution achieved the desired results. In operation 1156, the system may provide monitoring and planning outputs to the user. For example, the system may provide notice of payments or payment schedules, compliance information, solution monitoring and notices. Such steps may be under the control of the analysis engine.

It should be recognized that negotiating agency issues, e.g., the examination of a tax return, may be an ongoing process. As a result, users may need to log into and out of the system at a variety of points through out the process. In some instances, systems may implement operations to evaluate if profile or situational changes will affect a previously selected solution. For example, returning to FIG. 45b, operation 1160 illustrates one example of an evaluation of situational change. In operation 1160, when a user logs back into a system after some period of time, e.g., 1 month, an interrupt screen may appear on the user's computer and inquire about changes, e.g., profile or situational changes, which may affect the selected solution. Prompts may be solution specific and stored in a database. Situational and profile changes may also be determined based on additional analysis performed by the system, for example, if the system becomes aware of additional financial information based on its own retrieve. In operation 1162, the system may then determine if any determined changes require a new analysis. If a new analysis is required, the system may return to the creation of a problem specific profile as illustrated in operation 1164. For example, the system may perform or loop back to operation 1124. If situational changes do not require a new analysis, the system may proceed with the solution previously selected by the user, for example, in operation 1142.

FIG. 45d illustrates one example of a Fuzzy Meter 1130, which may perform similarly to any of the fuzzy meters described above, e.g. Fuzzy Meter 700. As noted previously, if a fuzzy meter determines that there is insufficient certainty, the system may provide an output for conducting an agency interview. That interview may be conducted, for example, by an IRS service provide as illustrated in operation 1170, by a system user as illustrated in operation 1172. The system may also address fuzziness based on user understanding, e.g., without an interview, as illustrated in operation 1174.

As clear from the disclosure above, the inventions contained herein include a variety of methods, systems, software, and software storage media. For example, one embodiment includes a method for generating an electronic output in response to an examination of a customer's tax return using a tax analysis system (TAS) server. In this embodiment, the method comprises: electronically extracting customer tax records; electronically transforming the extracted tax records using a record transforming code segment (RecTCS) to create a transformed tax record (TTRec) for the customer; and analyzing TTRec using an analysis engine code segment (AECS) contained on the TAS server. The method may also include generating an electronic output based on AECS analysis.

Another embodiment includes a web server-based method for generating an electronic output in response to an examination of a customer's tax return using a tax analysis system (TAS) server. In this embodiment, the method comprises electronically extracting customer tax records; electronically retrieving the extracted customer tax records to the TAS server; electronically transforming the extracted tax records using a record transforming code segment (RecTCS) to create a transformed tax record (TTRec) for the customer; storing the TTRec in an customer database; analyzing TTRec using an analysis engine code segment (AECS) contained on the TAS server; and generating an electronic output based on AECS analysis.

In either of these embodiments, analyzing TTRec using the AECS includes analysis based on a plurality of electronically transformed tax rules (TTRu) contained in a rules database. The TTRu may be transformed by a rule transforming code segment (RuTCS) or may be transformed manually, e.g., during database population. Analyzing TTRec using the AECS may also include analyzing based on a transformed examination issue (TEO. Examination issues are electronically transformed using an examination transforming code segment (ExTCS).

These methods may also include creating a customer account on the customer database using an account code segment (ACS). Creating the customer account may include sending website content from the TAS server to a customer computer.

Generating an electronic output may include generating interview questions for the customer using an interview generating code segment (IGCS). Interview questions may be sent to the customer, for example, as website content. Customer answers to the interview questions may be stored in the customer database. Generating an electronic output may also include generating a tax agency interview script using an interview generating code segment (IGCS). The tax agency interview script may be sent to the customer computer to allow, for example, the customer to interview the tax agency and obtain additional tax information. Tax agency answers may be stored electronically, for example, on the examination database. Electronic output may also include at least one output chosen from a prompt to update customer response, a compliance score, an assessment of a tax agency case, and a feedback request. Outputs may also include an agency analyzer report generated using a report generating code segment, which may be sent to the customer computer as website content or may be converted to paper format and mailed to the customer. Outputs may also include generating a validation correspondence to validate electronically extracted tax records.

AECS may test TTrec based on TTRu contained in the rules database. TTRu may include at least one of a pre-determined common tax filing error, a pre-determined common customer questions, a pre-determined financial means test, a pre-determined response strategy acceptance rate, a filing requirement for customer circumstances, and an eligibility indicator for tax debt. The AECS may also test TTrec based on TEI contained in the examination database. TEI include at least one issue chosen from a proposed agency change to a customer return based on a United States tax statute, a proposed agency change to a customer return based on a tax agency regulation, and an offer in compromise.

Methods may also include a second extraction of customer tax records based on the electronic output. For example, the second extraction may include records chosen from at least one of a customer circumstance indicator, a financial indicator, and a confirmation of current tax data. The TAS may use RecTCS to transform customer tax records from the second extraction.

Methods may also include creating an external reference database containing transformed external references (TEF). Exemplary TEF include at least one record chosen from of a credit score, an asset value chart, and a statistic on tax debt negotiations. TEF may be created by electronically transforming external references using a reference transformer code segment (RefTCS). Transformation may also be achieved in other ways, e.g., manually.

Another embodiment includes a web server-based method for generating an electronic output in response to an examination of a customer's tax return using a tax analysis system (TAS) server. In this embodiment, the method comprises creating a customer account in a customer database using an account code segment (ACS); electronically extracting predetermined customer tax records; electronically retrieving the extracted customer tax records to the TAS server; electronically transforming the extracted tax records using a record transforming code segment (RecTCS) to create a transformed tax record (TTRec) for the customer; storing the TTRec in the customer database; electronically transforming tax rules using a rule transforming code segment (RuTCS) contained on the TAS server to create transformed tax rules (TTRu); electronically transforming examination issues using an examination transforming code segment (ExTCS) contained on the TAS server to create transformed examination issues (TEO; analyzing TTRec using an analysis engine code segment (AECS) contained on the TAS server, wherein the analysis includes analysis based on at least one of TTRu, TTrec, and TEI; and generating an electronic output based on AECS analysis, wherein the electronic output includes at least one output chosen from a prompt to update customer response, a compliance score, an assessment of a tax agency case, and a feedback request.

Another embodiment includes a method for generating an electronic output in response to an examination of a customer's tax return using a tax analysis system (TAS) server. In this embodiment, the method comprises: electronically extracting customer tax records; sending an output to a customer, wherein the output is previously generated by electronically transforming the extracted tax records using a record transforming code segment (RecTCS) to create a transformed tax record (TTRec) for the customer, and analyzing TTRec using an analysis engine code segment (AECS) contained on the TAS server.

Further, analyzing tax records using the AECS includes analysis based on a plurality of tax rules contained in a rules database. Analyzing the tax records using the AECS may also include analyzing based on an examination issue, e.g. those issues mentioned above.

Method embodiments may similarly be explained or expanded in light of the various system descriptions contained herein. Further, while typical method examples will be implemented using hardware and processes noted above to transform items and generate outputs, it should be clear that in some method examples, some steps may be implemented in other ways, e.g., manually by tax professionals or using other systems, and still be within the broad scope of the overall teachings contained herein. In some embodiments, at least one of the steps performed by applicant's hardware and/or software may be performed in another way, e.g., manually. For example, at least one of extracting customer tax records; retrieving the extracted customer tax records to the TAS server; storing the tax records in a customer database; analyzing the tax records using an analysis engine code segment (AECS); and generating an output based on AECS analysis, may be performed, at least in part, manually or using components other than the systems and software noted above.

As is clear, the current disclosure is also directed to a variety of system embodiments. One embodiment includes a system for generating an electronic output in response to an examination of a customer's tax return. The system comprises a tax analysis system (TAS) server including a retriever code segment (RCS), a transformer code segment, an analysis engine code segment (AECS), and an output code segment.

Another system embodiment includes a system for generating an electronic output in response to an examination of a customer's tax return. In this embodiment, the system comprises a tax analysis system (TAS) server including a retriever code segment (RCS), a record transformer code segment (RecTCS), and an analysis engine code segment (AECS). A customer database is in communication with the RecTCS and the AECS, wherein the customer database includes transformed tax records (TTRec). A rules database is in communication with the AECS, wherein the rules database contains transformed tax rules (TTRu). An examination database is in communication with the AECS, wherein the examination database contains transformed examination issues (TED.

The system may also include any of a rules transformer code segment (RuTCS) configured to generate the TTRu; an examination transformer code segment (ExTCS) configured to generate the TEI; a reference transformer code segment (RefTCS) configured to generate transformed external references (TEF); a report generating code segment; and an agency analyzer report. System embodiments are not intended to be mutually exclusive, and parts from one embodiment or example, may be interchanged or modified according to the disclosure contained herein.

The disclosure is also directed to computer-readable media, e.g., a floppy disk, CD, or flash drive, comprising at least one of a retriever code segment (RCS), a transformer code segment, an analysis engine code segment (AECS), and an output code segment.

In other embodiments, the disclosure is directed to web server-based methods for generating an electronic output in response to an examination of a customer's records on file in an agency using an analysis system (AS). Exemplary agencies include at least one agency within at least one of the Department of Agriculture, the Department of Commerce, the Department of Defense, the Department of Education, the Department of Energy, the Department of Health and Human Services, the Department of Homeland Security, the Department of Housing and Urban Development, the Department of the Interior, the Department of Justice, the Department of Labor, the Department of State, the Department of Transportation, the Department of the Treasury, the Department of Veterans Affairs, independent agencies, state and local counterparts to any of the above, etc. Examples of specific agencies and other groups may include Social Security Administration; Health and Human Services—specifically, the Centers for Medicare and Medicaid Services (CMS); Transportation Security Administration; Employment Security Administration; Immigration and Naturalization Services; Armed Forces; Disability Employment Office; Employee Benefit Security Administration (including the PBGC); EEOC; FAA; Farm Credit Administration; Federal Student Aid-US Dept of Education; Veteran's Affairs Administration and Veterans Benefits Administration; Office of Personnel Management, including the Dept of Agriculture that administers all government payroll and benefits; Office of Thrift Supervision (holds all Federal Government Thrift Savings Plan data); United States Postal Service; Railroad Retirement Board (like SSA); Small Business Administration; Treasury Department (bonds, etc.); Medicaid administration; Universities—including financial aid and student records; State benefits and state employee information agencies/administrators; Secretary of State offices and business license offices; Department of Motor Vehicles; Unemployment Offices; Division of Drivers Licenses; State Human Resources Departments; State Education Departments; Local Property tax offices, etc.

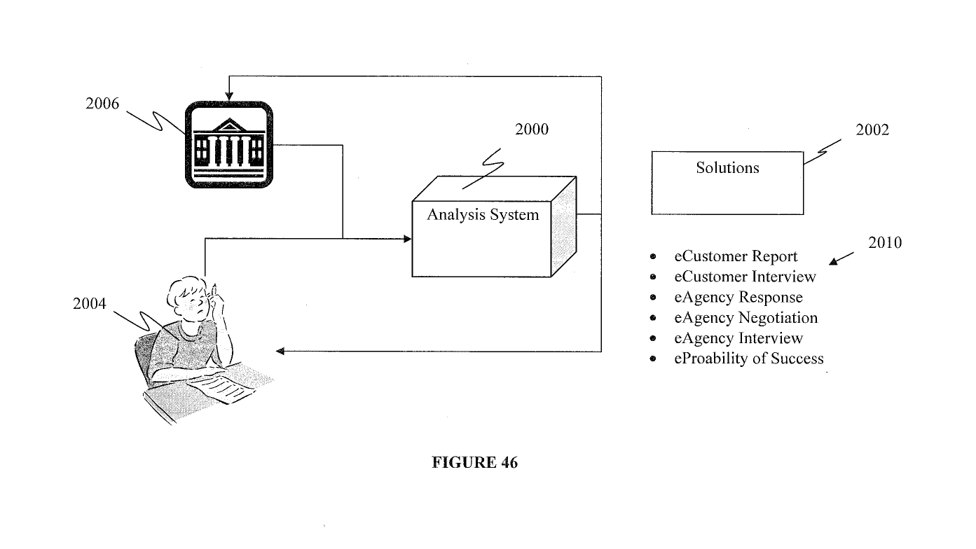

FIG. 46 represents a conceptual diagram of an analysis system (AS) 2000. AS 2000 performs operations to deliver solutions 2002 to a customer 2004 trying to resolve issues related to customer records in an agency or organization 2006. Exemplary solutions may vary from agency to agency, but will be comprised of at least one electronic output, e.g, any of outputs 2010.

AS systems and methods may be similar to any of the TAS systems and methods described above, and support for the AS systems and methods may be found in the TAS systems and methods described above, including the accompanying Figures and Tables. For example, the AS system may be located on an AS server, similarly to described in relation to the figures illustrating the TAS. Methods may comprise electronically extracting customer records; electronically sending the extracted customer records to the AS server; electronically transforming the extracted records using a record transforming code segment (RecTCS) to create a transformed record (TRec) for the customer; storing the TRec in a customer database; analyzing TRec using an analysis engine code segment (AECS) contained on the AS server; and generating an electronic output based on AECS analysis.

In other embodiments, the disclosure is directed to systems for generating an electronic output in response to an examination of a customer's records. For example, the system may comprise a analysis system (AS) server including a retriever code segment (RCS), a transformer code segment, an analysis engine code segment (AECS), and an output code segment. Using methods and systems according to these AS embodiments, other agency issues will also be readily resolved.

Numerous characteristics and advantages have been set forth in the foregoing description, together with details of structure and function. The disclosure, however, is illustrative only, and changes may be made in detail, especially in matters of shape, size, and arrangement of parts, within the principle of the invention, to the full extent indicated by the broad general meaning of the terms in which the general claims are expressed. It is further noted that, as used in this specification, the singular forms “a,” “an,” and “the” include plural referents unless expressly and unequivocally limited to one referent. Again, it should also be clear that the various embodiments and examples described herein are not intended to be mutually exclusive unless expressly indicated otherwise. For example, components of one TAS example or embodiment may be implemented in another TAS example or embodiment. Similarly, steps from one method example or embodiment disclosed herein may be implemented in another example or embodiment herein.

TABLE 1

| | | |
|---|---|---|
| 1 | Are you in IRS Collection? | Status |
| 2 | Amount owed | Status |
| 3 | Assessed amount owed | Status |
| 4 | What years do I owe for? | Status |
| 5 | Do you have a non-liable spouse/partner? | Status |
| 6 | Have you filed all of your tax returns? | Compliance |
| 7 | Has the IRS filed tax returns on your behalf? | Compliance |
| 8 | Do you have an assessment that needs correction? | Compliance |
| 9 | Have they used extension in past? | History |
| 10 | (from 9) If yes, how long of an extension have they | History |
| | received. | |
| 11 | For each year over 6 years ago- what is the CSED for | History |
| | each year? | |
| 12 | What is the CSED for each year? | History |
| 13 | Age | Profile |
| 14 | Health | Profile |
| 15 | Education | Profile |
| 16 | Professional designations | Profile |
| 17 | Self-employment | Profile |
| 18 | Income History | Profile |
| 19 | Recreational and non-essential assets | Profile |
| 20 | Marital Status | Profile |
| 21 | Number/Age of Dependents | Profile |
| 23 | Can they full pay by borrowing, refinancing, selling | Liquidity |
| | assets, etc.? (relates to 23, 25, or 28) If yes, what | |
| | sources will you derive the | |
| 24 | means to pay the liability? | Liquidity |
| 25 | Can they pay down under $25K by borrowing, re- | Liquidity |
| | financing, selling assets, etc.? | |
| 26 | Can you afford the down payment and/or the OIC if it | Liquidity |
| | is accepted? | |
| 27 | Do you have a tax lien for any years? | Liquidity |
| 28 | Can they pay down the liability by borrowing, re- | Liquidity |
| | financing, selling assets, etc.? | |
| 29 | What can you afford to pay monthly to the IRS? | Financials |
| 30 | After pay down, what can you afford to pay monthly | Financials |
| | to the IRS? | |
| 31 | Will the monthly payment pay the IRS within 60 | Financials |
| | months? | |
| 32 | 433A/F Data | Financials |
| 33 | Allowable living expense limits | Financials |
| 34 | What are necessary living expenses but exceeds ALE | Financials |
| | stds (measures against 33) | |
| 35 | Will the payments full pay the liability before the | Financials |
| | CSEDs expire? | |
| 36 | Equity in liquidating asset | Financials |
| 37 | Reasonable Collection Potential | Financials |

TABLE 2
30-60 Day to Full Pay

Are you in ACS?
Amount owed
Assessed amount owed
What years do I owe for?
Have you filed all of your tax returns?
Have they used extension in past?
If yes, how long of an extension have they received?
Can they full pay by borrowing, refinancing, selling assets, etc.?
If yes, what sources will you derive to pay the liability?

TABLE 3
SLIA

Are you in IRS Collection?
Amount owed
Assessed amount owed
What years do I owe for?
Have you filed all of your tax returns?
For each year over 6 years ago-what is the CSED for each year?
What can you afford to pay monthly to the IRS?

TABLE 4
Paydown and then SLIA

Are you in IRS Collection?
Amount owed
What years do I owe for?
Have you filed all of your tax returns?
Have they used extension in past?
If yes, how long of an extension have they received?
For each year over 6 years ago-what is the CSED for each year?
Can they pay down under $25K by borrowing, refinancing, selling assets,
etc.?
If yes, what sources will you derive to pay the liability?
Do you have a tax lien for any years?
What can you afford to pay monthly to the IRS?
After pay down, what can you afford to pay monthly to the IRS?

TABLE 5
IA based on ability to pay

Are you in IRS Collection?
Amount owed
What years do I owe for?
Do you have a non-liable spouse/partner?
Have you filed all of your tax returns?
What is the CSED for each year?
What can you afford to pay monthly to the IRS?
433A/F Data
Allowable living expense limits

TABLE 6
Conditional IA

Amount owed
What years do I owe for?
Do you have a non-liable spouse/partner?
Have you filed all of your tax returns?
What can you afford to pay monthly to the IRS?
Will the monthly payment pay the IRS in 60 months?
433A/F Data
Allowable living expense limits
What are necessary living expenses but exceeds ALE stds

TABLE 7
Lifestyle IA

Amount owed
What years do I owe for?
Do you have a non-liable spouse/partner?
Have you filed all of your tax returns?
What can you afford to pay monthly to the IRS?
433A/F Data
Allowable living expense limits
What are necessary living expenses but exceeds ALE stds
Will the payments full pay the liability before the CSEDs expire?

TABLE 8
CNC

Amount owed
What years do I owe for?
Do you have a non-liable spouse/partner?
Have you filed all of your tax returns?
Can they pay down the liability by borrowing, refinancing, selling assets,
etc.?
If yes, what sources will you derive to pay the liability?
What can you afford to pay monthly to the IRS?
433A/F Data
Allowable living expense limits

TABLE 9
Lien Services

Amount owed
What years do I owe for?
Do you have a non-liable spouse/partner?
Have you filed all of your tax returns?
Equity in liquidating asset

TABLE 10
PPIA

Amount owed
What years do I owe for?
Do you have a non-liable spouse/partner?
Have you filed all of your tax returns?
Can they pay down the liability by borrowing, refinancing, selling assets,
etc.?
If yes, what sources will you derive to pay the liability?
What can you afford to pay monthly to the IRS?
433A/F Data
Allowable living expense limits

TABLE 11
OIC: DATC (lump sum and 24 month)

Amount owed
What years do I owe for?
Do you have a non-liable spouse/partner?
Have you filed all of your tax returns?
Client Profile Data
Age
Health
Education
Professional designations
Self-employment
Income History
Recreational and non-essential assets
Marital Status
Number/Age of Dependents
Can you afford the down payment and/or the OIC if it is accepted?
What can you afford to pay monthly to the IRS?
433A/F Data
Allowable living expense limits
Reasonable Collection Potential

TABLE 12
Interim Agreement until Assessment is Corrected

Are you in IRS Collection?
Amount owed
What years do I owe for?
Do you have a non-liable spouse/partner?
Have you filed all of your tax returns?
Has the IRS filed tax returns on your behalf?
Do you have an assessment that needs correction?
What is the CSED for each year?
What can you afford to pay monthly to the IRS?
433A/F Data
Allowable living expense limits

TABLE 13
Fuzzy Meter Questionnaire

| Factors | Increase | Decrease | Method |
|---|---|---|---|
| Number of years owed? | As number of years increase | Dramatic decrease with only a | Indirectly gathered from with |
| | | single year | years the user owes. |
| Amount owed (in total, all years combined) | If round numbers provided by | Dramatic decrease with only a | User enters in a numerical field. |
| | user | single year | |
| Which years do you owe for? | With older years (>3 years old) | Dramatic decrease with only a | Dropdown list, with opportunity to |
| | | single year | add as many as necessary. |
| Which letters have you received from | As number of letters increase | If 2 or fewer letters have been | Dropdown list, with opportunity to |
| the IRS? | | received | add as many as necessary, list |
| | | | should contain “Letter not listed” |
| | | | or “other” as an option. |
| Do you have an EIN? | If yes | N/A | |
| Are you self-employed, part of a partnership, | If yes | N/A | |
| or owner/part-owner of an S-Corp? | | | |
| Have you ever failed to file a tax return | If yes | If no | Dropdown list, with opportunity to |
| in any year? | | | add as many as necessary. |
| If so, which year? | As number of years increase | N/A | |
| Has the IRS ever filed a return for you? | If yes | N/A | |
| Has the IRS added penalties to your liability? | If unsure | If yes or no | |
| If so, what type and enter amount? | N/A | Dramatic decrease if known | Dropdown list, with opportunity to |
| | | | add several to the list, and an |
| | | | accompanying numerical field to |
| | | | enter amount. |
| Are you being audited now, or have you been | If yes | If no | |
| audited in the last three years? | | | |
| If multiple unfiled years AND multiple | Add each previous factor to | N/A | Indirectly gathered from answers |
| years owed: | overall index again | | to other questions. |

TABLE 14
SLIA TERM CALCULATED
(From SLIA Level1)
Months remaining in CSED (MRCSED) calculated.

| | | |
|---|---|---|
| SLIA Term calculated. | If user entered data, estimate as: 12 | |
| | months minus (# of months between | |
| | Current Month & Year and (April of | |
| | oldest tax year owed + 1 year)) | |
| | If IRS Interview present, choose | |
| | earliest CSED to expire and calculate | |
| | CSED minus current year and month | |
| | (in months) | |
| | If MRCSED minus 6 months > | |
| | or = 60 months, then 60 months is | |
| | SLIA Term | |
| SLIA Term qualification made and | If MRCSED minus 6 months < 60 | Taxpayer might benefit from SLIA, even though CSEDs expire in < |
| presented to user. | months, then MRCSED − 6 months is | 60 months. User might have multiple years with CSEDs < 60 |
| | the SLIA Term (A “non-standard” | months. Each year might have its own SLIA Term and, therefore, |
| | SLIA for our purposes. We need to | minimum SLIA payment to ensure the balance is paid prior to CSED |
| | produce calculations to deal with | expiration. (with a 6 month cushion). CSEDs must be matched with |
| | multiple years with different “short” | balances, sorted, and a minimum payment determined to ensure that |
| | CSEDs and balances.) | each balance is paid in full by its deadline. |
| | Present maximum term of IA without | |
| | full financial disclosure. Present | |
| | explanation of the SLIA Term and | |
| | ways in which the user can shorten | |
| | the life of the installment agreement. | |

TABLE 15
GENERAL TIPS

Not Advised:
Taxes are illegal/unconstitutional
Any type of political
I will flee the country.
I am withholding part (or all) of my taxes because of my opposition to the government policy/program of .
Any false or misleading argument.
Threats against the IRS, the government, or any of their employees (personal or general).
Any statement that could be construed to mean that you do not intend to bring the matter to a mutually acceptable resolution.
Derogatory comments toward the tax system, the IRS, or the individual with whom you are speaking.
Advised:
Answer the questions posed by the IRS honestly and completely, but limit your response to their question asked of you.
Avoid making small talk or volunteering information that is not directly relevant to your desired resolution or the questions asked of you.
Remember, you are speaking to a person on the other end of the line. At the same time, recognize that the individual
is limited by beauracratic policies and procedures.
If the individual has any latitude within the rules applicable to your situation, you are more likely to receive favorable treatment if: you treat the
individual with respect and understanding.
You share the human element of your situation.
Bear in mind that IRS employees hear a lot of stories of financial, medical, or other types of difficulty and are often skeptical of them. If you have
documentation to substantiate the history you are sharing, you may receive more favorable treatment
you avoid screaming or yelling during the conversation.
You are patient with the IRS representative with whom you are speaking, as they are working on a very inefficient computer system and have to access
several information sources during the course of a typical interaction with a taxpayer such as yourself.
Understand IRS system for answering taxpayer calls.
Bear in mind that unless you are working with a Revenue Officer, a Revenue Agent, the Criminal Investigations Division or a Taxpayer Advocate, you
will probably never speak to the same IRS employee twice.
It is important to note that even if you hire an attorney, an Enrolled Agent, or a CPA, they will face he same situation and almost certainly will not
be speaking to the same IRS employee about your case on more than one occasion.
Make sure you know if your resolution is pending document review and/or managerial approval.
IRS employees will often communicate preliminary approval or qualification for a certain resolution. However, many resolutions require that documents
be submitted and reviewed by the IRS before the resolution is approved and/or that a manager review the data and approve the resolution before it is
official.
How much time you will need to allocate for the call.

TABLE 16
Example 1:
User situation:
System Determines that:

User Owes $9500 for 2006 and 2007
User Has filed all years except 2009- which is due Apr. 15, 2010 - when he files will owe

$800+

User is in an installment agreement with IRS for $279 (i.e. not under enforcement)

Has no tax lien

User has no monthly disposable income (“MDI”) according to actual income and

expenses allowed up to IRS allowable living standards

User has net equity in assets of $180,000 but cannot borrow against them due to

several restrictions

User has no penalties other than the statutory failure to pay penalty of 3% annually

based on the unpaid balance owed

Has no reasonable cause for abatement of penalties

User GOALS:
System determines that User has several goals including:

User wants an offer in compromise
User wants no tax lien
User wants penalties waived

Based on Situation and User GOALS, System Determines Alternatives:
Option 1: (Recommended solution)- stay in current IA and request some penalty relief

| | |
|---|---|
| A. | stay in current installment agreement of $279 to avoid a tax lien being filed |
| B. | call IRS and request $38 of failure to pay penalties to be abated for 2006 based on the |

first year penalty non-compliance abatement program

Option 2: (achievable but not recommended if user GOAL is to avoid a tax lien)- negotiate CNC

| a. | Negotiate a currently not collectible (CNC) status based on presenting detailed financial |
|---|---|
| | information to the IRS |
| b. | Tasks would involve: getting documentation for all income and expenses, proof that |
| | cannot borrow against assets, completing all IRS forms, and calling the IRS with |
| | financials (with fax close by to send during the call) |
| c. | UNDERSTAND THAT A TAX LIEN WILL BE FILED UNDER YOUR NAME AT THE LOCAL |

COURTHOUSE AS YOU OWE OVER $5,000

System Notes that user does not qualify for an OIC as their net equity in assets exceeds the
amount of the tax liability owed
Example #2
User situation:
System determines that:

User owes $20,000 for 2009
User is current on all tax filings
User Has net assets of $240,000 - with $50,000 in cash in their bank account
User has filed all required returns
User has net MDI of $200 a month based on actual income and expenses v. IRS

allowable living expenses

IRS has issued a balance due notice (CP14)- hence, levy is not imminent for 90 days

User GOALS:
System determines that User has several goals including:

Not to pay IRS with available cash as they will be unemployed soon
User wants as low as a payment as possible- around $200 a month
User does not want a tax lien

Based on Situation and User GOALS, System Determines Alternatives:
Option 1: (Recommended based on User GOAL of not wanting to expend liquid assets)-
Streamline IA before L1058 is issued

| | |
|---|---|
| a. | Call the IRS and request a payment of $400 a month for 60 months to pay off liability in |

full to avoid a tax lien and a financial investigation into users assets

Option 2: Pay the IRS in full

| | |
|---|---|
| a. | Pay off the IRS with the liquid funds available to you - this will avoid a lien |

User does not qualify for a $200 a month payment as this would require full financial disclosure
resulting in the IRS requesting to pay off the debt with assets.
Example #3:
User situation:
System determines that:

User owes $50,000 for 2009 (just filed)
User is current on all tax filings
User has net assets of $5,000 - no assets are liquid
User has filed all required returns
User has net MDI of $200 a month based on actual income and expenses v. IRS

allowable living expenses

User's annual income is $55,000 a year and is employed as a CPA
Has access to credit card advances of $30,000
IRS has issued a balance due notice (CP14)- hence, levy is not imminent for 90 days

User GOALS:
System determines that:

User wants an OIC for under $2000
User cannot pay more than $2000 in the next year
User does not want a tax lien

Based on Situation and User GOALS, System Determines Alternatives:
Option 1: (Recommended) - Negotiate a partial pay installment arrangement of $200 a month

| a. | Provide a full financial disclosure to the IRS with all income, expenses, assets and |
|---|---|
| | liabilities via phone (have fax ability available while on call) |
| b. | Call/Contact the IRS and provide: |

a. Form 433F with all back up documents to prove all items

| | |
|---|---|
| c. | You will receive a Federal Tax lien as your amount owed is over $25,000 and your are a |

partial pay installment agreement

Option 2: Raise your OIC offer to $29,000 to the IRS and file for an OIC (not recommended
unless you are sure that you qualify as it will cost you $5950 to apply and the remainder within 4
months of the acceptance of the OIC)- this is a full financial investigation

| a. | Complete full profile for detailed financial history |
|---|---|
| b. | Complete Form 656, 433A, and provide all detailed documents proving income, |
| | expenses, assets and liabilities. |
| c. | Negotiate the OIC with the IRS COIC Unit (approximate time to complete: 7 months) |

Option 3: Borrow $25,100, pay the IRS, and get into a streamline agreement for $500- limiting
your financial disclosure

| a. | Borrow on your available credit and pay the IRS to get the balance under $25,000 |
|---|---|
| b. | Immediately after the IRS has posted the payment, negotiate a payment of $500 a |
| | month for 60 months |
| c. | Ask the IRS not to file a tax lien (they will not normally if you make arrangements to pay |

in this method)

If there is not a method that solves all of the users goals-user can choose the method that is the
best alternative for them.

1. A web server-based method for generating an electronic output in response to an examination of a customer's tax records on file in an agency using a tax analysis system (TAS) server, the method comprising:
electronically extracting customer tax records;
electronically retrieving the extracted customer tax records to the TAS server;
electronically transforming the extracted tax records using a record transforming code segment (RecTCS) to create a transformed tax record (TTRec) for the customer;
storing the TTRec in a customer database;
analyzing TTRec using an analysis engine code segment (AECS) contained on the TAS server; and
generating an electronic output based on AECS analysis.

2. The method of claim 1, wherein analyzing TTRec using the AECS includes analysis based on a plurality of electronically transformed tax rules (TTRu) contained in a rules database.

3. The method of claim 1, further including electronically transforming tax rules using a rule transforming code segment (RuTCS).

4. The method of claim 3, wherein the RuTCS is contained on the TAS server.

5. The method of claim 1, wherein the analyzing TTRec using the AECS includes analyzing based on a transformed examination issue (TED.

6. The method of claim 5, further including electronically transforming examination issues using an examination transforming code segment (ExTCS).

7. The method of claim 6, wherein the ExTCS is contained on the TAS server.

8. The method of claim 1, further including creating a customer account in the customer database using an account code segment (ACS).

9. The method of claim 8, wherein creating the customer account includes sending website content from the TAS server to a customer computer.

10. The method of claim 1, wherein generating an electronic output includes generating interview questions for the customer using an interview generating code segment (IGCS).

11. The method of claim 10, further including sending the interview questions to the customer computer as website content.

12. The method of claim 10, including electronically storing customer answers to the interview questions on the customer database.

13. The method of claim 1, wherein the generating an electronic output includes generating a tax agency interview script using an interview generating code segment (IGCS).

14. The method of claim 13, further including sending the tax agency interview script to the customer computer.

15. The method of claim 14, further including interviewing a tax agency using the tax agency interview script and electronically storing tax agency answers derived from the interview.

16. The method of claim 15, wherein the tax agency answers are stored on the examination database.

17. The method of claim 1, wherein the AECS tests TTrec based on TTRu contained in the rules database.

18. The method of claim 17, wherein the TTRu include at least one of a pre-determined common tax filing error, a pre-determined common customer questions, a pre-determined financial means test, a pre-determined response strategy acceptance rate, a filing requirement for customer circumstances, and an eligibility indicator for tax debt.

19. The method of claim 17, wherein the AECS tests TTrec based on TTRu contained in the rules database and TEI contained in the examination database.

20. The method of claim 19, wherein the TEI include at least one issue chosen from a proposed agency change to a customer return based on a United States tax statute, a proposed agency change to a customer return based on a tax agency regulation, and an offer in compromise.

21. The method of claim 1, wherein the electronic output includes at least one output chosen from a prompt to update customer response, a compliance score, an assessment of a tax agency case, and a feedback request.

22. The method of claim 21, wherein the electronic output includes a feedback request, and wherein the provided feedback is used for at least one of updating the customer database, updating a rules database, and prioritizing products in a products suite.

23. The method of claim 21, wherein the electronic output is sent to the customer computer as website content.

24. The method of claim 1, further including a second extraction of customer tax records based on the electronic output, wherein the second extraction includes records chosen from at least one of a customer circumstance indicator, a financial indicator, and a confirmation of current tax data.

25. The method of claim 23, further including using the RecTCS to transform customer tax records from the second extraction.

26. The method of claim 1, further including an external reference database containing transformed external references (TEF).

27. The method of claim 26, wherein the TEF includes at least one record chosen from a credit score, an asset value chart, and a statistic on tax debt negotiations.

28. The method of claim 1, further including electronically transforming external references using a reference transformer code segment (RefTCS).

29. The method of claim 1, further including generating an agency analyzer report based on the electronic output using a report generating code segment.

30. The method of claim 29, wherein the agency analyzer report is sent to the customer computer as website content

31. The method of claim 1, further including generating a validation correspondence to validate electronically extracted tax records.

32. The method of 1, wherein the tax records include a tax return.

32. A web server-based method for generating an electronic output in response to an examination of a customer's tax records on file in an agency using a tax analysis system (TAS) server, the method comprising:
creating a customer account in a customer database using an account code segment (ACS);
electronically extracting predetermined customer tax records;
electronically retrieving the extracted customer tax records to the TAS server;
electronically transforming the extracted tax records using a record transforming code segment (RecTCS) to create a transformed tax record (TTRec) for the customer;
storing the TTRec in the customer database;
electronically transforming tax rules using a rule transforming code segment (RuTCS) contained on the TAS server to create transformed tax rules (TTRu);
electronically transforming examination issues using an examination transforming code segment (ExTCS) contained on the TAS server to create transformed examination issues (TEI)
analyzing TTRec using an analysis engine code segment (AECS) contained on the TAS server, wherein the analysis includes analysis based on at least one of TTRu, TTrec, and TEI; and
generating an electronic output based on AECS analysis, wherein the electronic output includes at least one output chosen from a prompt to update customer response, a compliance score, an assessment of a tax agency case, and a feedback request.

33. A method for generating an electronic output in response to an examination of a customer's tax records on file in an agency using a tax analysis system (TAS) server, the method comprising:
electronically extracting customer tax records;
electronically transforming the extracted tax records using a record transforming code segment (RecTCS) to create a transformed tax record (TTRec) for the customer; and
analyzing TTRec using an analysis engine code segment (AECS) contained on the TAS server.

34. A system for generating an electronic output in response to an examination of a customer's tax records, the system comprising:
a tax analysis system (TAS) server including
a retriever code segment (RCS),
a record transformer code segment (RecTCS), and
an analysis engine code segment (AECS),
an customer database in communication with the RecTCS and the AECS, wherein the customer database includes transformed tax records (TTRec);
a rules database in communication with the AECS, wherein the rules database contains transformed tax rules (TTRu); and
an examination database in communication with the AECS, wherein the examination database contains transformed examination issues (TEO.

35. The system of claim 34, further including a rules transformer code segment (RuTCS) configured to generate the TTRu.

36. The system of claim 34, wherein the TAS includes a rules transformer code segment (RuTCS) configured to generate the TTRu.

37. The system of claim 34, further including an examination transformer code segment (ExTCS) configured to generate the TEI.

38. The system of claim 34, wherein the TAS includes an examination transformer code segment (ExTCS) configured to generate the TEI.

39. The system of claim 34, further including a reference transformer code segment (RefTCS) configured to generate transformed external references (TEF).

40. The system of claim 34, wherein the TAS includes a reference transformer code segment (RefTCS).

41. The system of claim 34, wherein the TAS includes report generating code segment.

42. The system of claim 34, furthering including an agency analyzer report.

43. A computer-readable media comprising at least one of a retriever code segment (RCS), a transformer code segment, an analysis engine code segment (AECS), and an output code segment.

44. A method for generating an output in response to an examination of a customer's tax records on file in an agency using a tax analysis system (TAS) server, the method comprising:
extracting customer tax records;
retrieving the extracted customer tax records to the TAS server;
storing the tax records in a customer database;
analyzing the tax records using an analysis engine code segment (AECS); and
generating an output based on AECS analysis.

45. The method of claim 44, wherein analyzing tax records using the AECS includes analysis based on a plurality of tax rules contained in a rules database.

46. The method of claim 44, wherein the analyzing the tax records using the AECS includes analyzing based on an examination issue (TEO.

47. The method of claim 44, further including creating a customer account on the customer database using an account code segment (ACS).

48. The method of claim 44, wherein generating an output includes generating interview questions for the customer using an interview generating code segment (IGCS).

49. The method of claim 48, further including sending the interview questions to the customer computer as website content.

50. The method of claim 49, including electronically storing customer answers to the interview questions on the customer database.

51. The method of claim 44, wherein the generating an output includes generating a tax agency interview script using an interview generating code segment (IGCS).

52. The method of claim 51, further including sending the tax agency interview script to the customer computer.

53. The method of claim 52, further including interviewing a tax agency using the tax agency interview script and electronically storing tax agency answers derived from the interview.

54. The method of claim 44, wherein the output includes at least one output chosen from a prompt to update customer response, a compliance score, an assessment of a tax agency case, and a feedback request.

55. The method of claim 54, further including a second extraction of customer tax records based on the electronic output.

56. The method of claim 55, wherein the second extraction includes records chosen from at least one of a customer circumstance indicator, a financial indicator, and a confirmation of current tax data.

57. The method of claim 44, further including an external reference database containing external references.

58. The method of claim 57, wherein the external references includes at least one record chosen from a credit score, an asset value chart, and a statistic on tax debt negotiations.

59. The method of claim 44, further including generating an agency analyzer report.
